(19) United States
(12) Patent Application Publication
(10) Pub. No.: US 2024/0306033 A1
(43) Pub. Date: Sep. 12, 2024

(54) LOGICAL CHANNEL INDICATION FOR ENHANCED BUFFERED DATA INFORMATION REPORTING

(71) Applicant: QUALCOMM Incorporated, San Diego, CA (US)

(72) Inventors: Ahmed Elshafie, San Diego, CA (US); Linhai He, San Diego, CA (US); Huilin Xu, Temecula, CA (US); Diana Maamari, San Diego, CA (US); Ahmed Attia Abotabl, San Diego, CA (US)

(21) Appl. No.: 18/179,736

(22) Filed: Mar. 7, 2023

(51) Int. Cl. H04W 28/02; H04L 5/00

(52) U.S. Cl. CPC H04W 28/0278; H04L 5/0048; H04W 72/1268; H04W 72/1273

(57) ABSTRACT

This disclosure provides systems, methods, and devices for wireless communication that support enhanced buffered data information reporting. In a first aspect, a device for wireless communication includes at least one processor and a memory coupled to the at least one processor. The at least one processor is configured to receive a control channel transmission including logical channel information for transmission of buffered data information from a second network node. The at least one processor is further configured to transmit the buffered data information to the second network node based on the logical channel information in one or more uplink resources. Other aspects and features are also claimed and described.

### TECHNICAL FIELD

Aspects of the present disclosure relate generally to wireless communication systems, and more particularly, to enhanced buffered data information reporting. Some features may enable and provide improved communications, including logical channel indications for buffered data information reporting which may enable transmission of buffered data information with reduce latency.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes receive a control channel transmission including logical channel information for transmission of buffered data information from a second network node. The method further includes transmit the buffered data information to the second network node based on the logical channel information in one or more uplink resources.

In an additional aspect of the disclosure, an apparatus configured for wireless communication is disclosed. The apparatus includes at least one processor, and a memory coupled to the at least one processor. The at least one processor is configured to receive a control channel transmission including logical channel information for transmission of buffered data information from a second network node. The at least one processor is further configured to transmit the buffered data information to the second network node based on the logical channel information in one or more uplink resources.

In an additional aspect of the disclosure, an apparatus configured for wireless communication is disclosed. The apparatus includes means for receive a control channel transmission including logical channel information for transmission of buffered data information from a second network node. The apparatus further includes means for transmit the buffered data information to the second network node based on the logical channel information in one or more uplink resources.

In an additional aspect of the disclosure, a non-transitory computer-readable medium stores instructions that, when executed by a processor, cause the processor to perform operations including receive a control channel transmission including logical channel information for transmission of buffered data information from a second network node. The operations further include transmit the buffered data information to the second network node based on the logical channel information in one or more uplink resources.

In another aspect of the disclosure, a method of wireless communication includes transmitting a control channel transmission including logical channel information for transmission of buffered data information to a second network node. The method further includes receiving the buffered data information from the second network node based on the logical channel information in one or more uplink resources.

In an additional aspect of the disclosure, an apparatus configured for wireless communication is disclosed. The apparatus includes at least one processor, and a memory coupled to the at least one processor. The at least one processor is configured to transmit a control channel transmission including logical channel information for transmission of buffered data information to a second network node. The at least one processor is further configured to receive the buffered data information from the second network node based on the logical channel information in one or more uplink resources.

In an additional aspect of the disclosure, an apparatus configured for wireless communication is disclosed. The apparatus includes means for transmitting a control channel transmission including logical channel information for transmission of buffered data information to a second network node. The apparatus further includes means for receiving the buffered data information from the second network node based on the logical channel information in one or more uplink resources.

In an additional aspect of the disclosure, a non-transitory computer-readable medium stores instructions that, when executed by a processor, cause the processor to perform operations including transmitting a control channel transmission including logical channel information for transmission of buffered data information to a second network node. The operations further include receiving the buffered data information from the second network node based on the logical channel information in one or more uplink resources.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a diagram of an example of buffer status reporting (BSR) operations according to one or more aspects.

FIG. 4 is a block diagram illustrating an example wireless communication system that supports enhanced buffered data information reporting according to one or more aspects.

FIG. 5 is a timing diagram illustrating an example process that supports enhanced buffered data information reporting according to one or more aspects.

FIGS. 6A and 6B are each a timing diagram illustrating an example process that supports enhanced buffered data information reporting according to one or more aspects.

FIGS. 7A and 7B are each a timing diagram illustrating an example process that supports enhanced buffered data information reporting according to one or more aspects.

FIG. 8 is a table illustrating an example of joint indications for feedback information and buffered data information indications for enhanced buffered data information reporting according to one or more aspects.

FIG. 9 is a timing diagram illustrating an example process that supports enhanced buffered data information reporting according to one or more aspects.

FIGS. 10A and 10B are each a timing diagram illustrating an example process that supports buffered data information reporting according to one or more aspects.

FIG. 11 is a block diagram illustrating encoding examples for enhanced buffered data information reporting according to one or more aspects.

FIG. 12 is a flow diagram illustrating an example process that supports enhanced buffered data information reporting according to one or more aspects.

FIG. 13 is a flow diagram illustrating an example process that supports enhanced buffered data information reporting according to one or more aspects.

FIG. 14 is a block diagram of an example UE that supports enhanced buffered data information reporting according to one or more aspects.

FIG. 15 is a block diagram of an example base station that supports enhanced buffered data information reporting according to one or more aspects.

Like reference numbers and designations in the various drawings indicate like elements.

### DETAILED DESCRIPTION

The detailed description set forth below, in connection with the appended, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably. A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology.

Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies.

Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

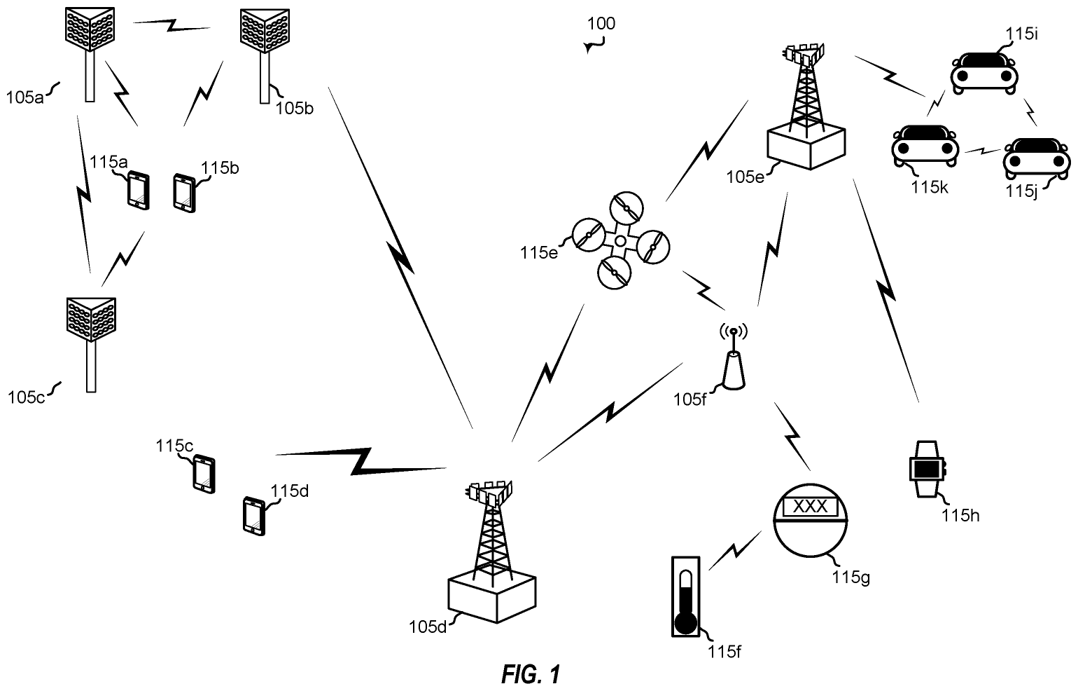

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in

FIG. 1 are likely to have related counterparts in other network arrangements including, for example, cellular-style network arrangements and non-cellular-style-network arrangements (e.g., device to device or peer to peer or ad hoc network arrangements, etc.). Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f.

Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

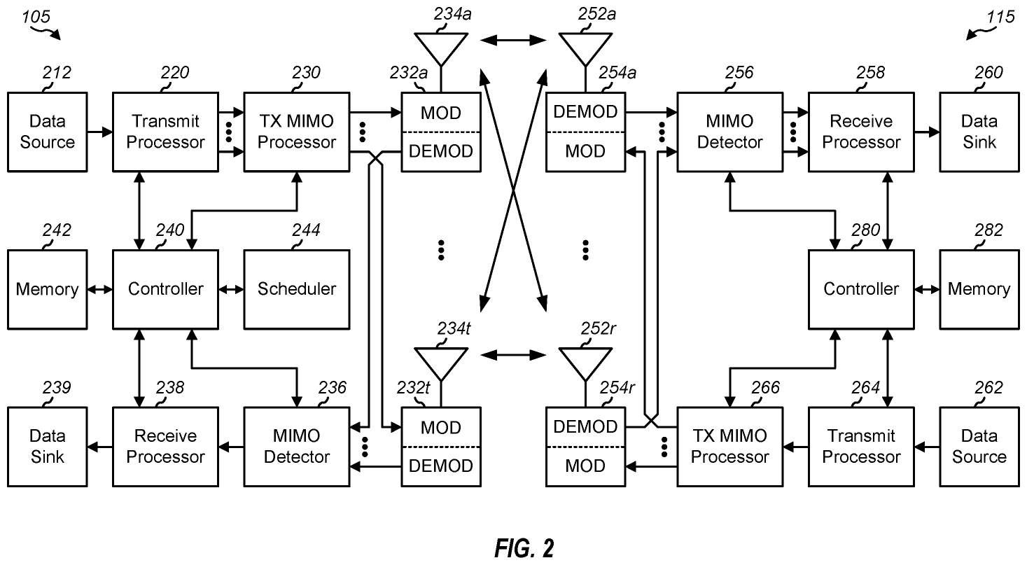

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

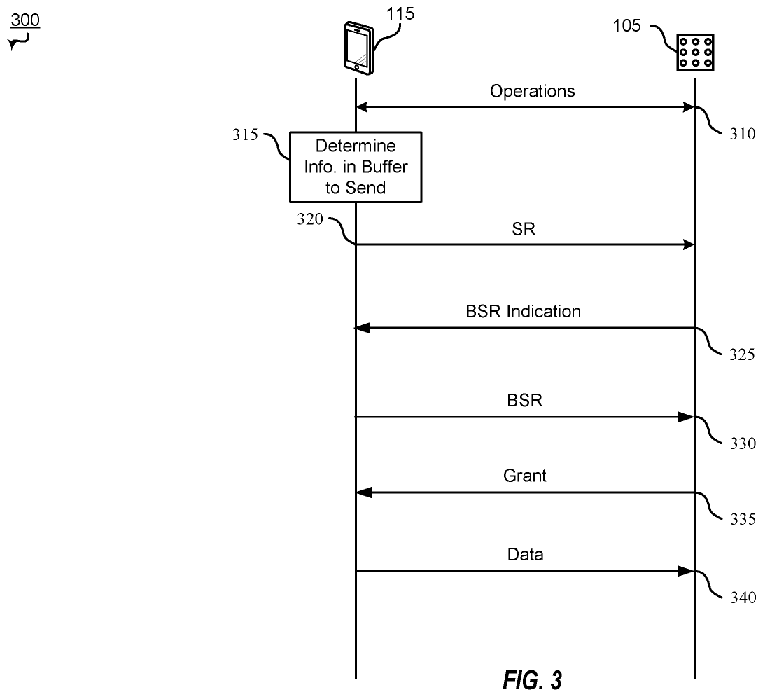

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 3-14, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

FIG. 3 illustrates an example of buffer status reporting operations. In FIG. 3, buffer status reporting operations are shown for a UE reporting its buffer status, such as an amount of encoded data in a buffer the UE wants to transmit in uplink. FIG. 3 illustrates a timing diagram 300 of buffer status reporting operations for a UE 115 and a base station 105. The devices may engage in half and/or full-duplex operations. Full-duplex operations corresponds to transmitting and/or receiving data via multiple antennas at the same time. Half-duplex operation corresponds to transmitting or receiving data via a single antenna at a particular time.

UEs and network devices, such as UE 115 and the base station 105 may establish a uplink/downlink communication link (e.g., a Uu communication link), and the UE 115 may communicate with the base station 105 over the Uu communication link by transmitting and/or receiving transmissions. When a UE wishes to send uplink data or has more uplink data than it currently has uplink resources, the UE may indicate such a request to the network using a scheduling request and a buffer status report as shown in FIG. 3

During operation, at 310, the UE 115 and the base station 105 may establish and perform one or more operations on the communication link, such as transmitting and/or receiving data. For example, the UE 115 may transmit uplink data to the base station 105 and receive downlink data from the base station 105.

At 315, the UE 115 determines it has uplink information in a buffer to send. For example, the UE 115 may determine it has a threshold amount of encoded data in an encoded buffer or more uplink data than it has uplink resources (also referred to as uplink transmission resources).

At 320, the UE 115 transmits a scheduling request (SR) to the base station 105. For example, the UE 115 may transmit a control or a higher layer message, such as SR or SR message, indicating that the UE 115 has uplink data send or indicating a request for resources to send a buffer status report. The UE 115 may send the SR responsive to determining the UE 115 has a threshold amount of data in a buffer, has a buffer status report (BSR) to transmit, has no uplink resources to send the BSR in, or a combination thereof.

At 325, the base station 105 transmits a BSR indication to the UE 115. For example, the base station 105 transmits a control or a higher layer message, such as BSR indication message, indicating that the resources for the UE 115 to send the BSR in responsive to receiving the SR and/or an indication from the UE 115 that is has a BSR to send. The BSR indication may identify the resources for the UE 115 to report the BSR.

At 330, the UE 115 transmits a BSR to the base station 105. For example, the UE 115 may transmit a BSR transmission indicating an amount of uplink data it has or will have ready to send responsive to receiving the BSR indication from the base station 105. The UE 115 may send the BSR in uplink resources indicated by the BSR indication.

At 335, the base station 105 transmits an uplink grant to the UE 115. For example, the base station 105 may receive the BSR and determine what uplink resources the UE 115 is requesting or which uplink resources to assign to the UE 115. The base station 105 transmit an aperiodic or periodic grant in a control channel transmission or higher layer message indicating a uplink grant and uplink resources corresponding to the uplink grant. To illustrate, the base station 105 may transmit a PDCCH (e.g., UL scheduling DCI) transmission to the UE 115 indicating an aperiodic uplink grant/resource for the transmission of data indicated by the BSR report.

At 340, the UE 115 transmits uplink data to the base station 105. For example, the UE 115 may transmit a data channel transmission, such as a PUSCH transmission, including at least a portion of the encoded data in the buffer and which was indicated to the base station 105 in the BSR at 330. The UE 115 may receive the uplink grant, determine the uplink resources indicated by the uplink grant, and transmit the data in the uplink resources. In some implementations, the UE 115 may transmit multiple transmissions including the uplink data reported to the base station 105 in the BSR.

As illustrated in the operations of FIG. 3, there can be a substantial and impactful delay between the UE 115 wanting to send the data, such as determining data to send at 315, and actually sending the uplink data at 340. Specifically, in the current SR and BSR reporting scheme, a UE needs to wait for an UL slot to transmit a PUCCH with a positive SR. The UE then waits for a next uplink slot to transmit a BSR, and then waits again for another UL slot to be scheduled according to the BSR to finally send the encoded data/data in the buffer. With such as procedure and certain slot configurations, such as ‘DDDDU’ which has four downlink slots, the delay is at minimum 10 msec for a SCS of 15 kHz, assuming it is always possible that the UE can transmit a SR every/the next UL slot. In actuality, this may not be the case and additional delays, such as the average time between the generation of the positive SR at the UE and the corresponding PUCCH transmission opportunity and duration, further increase this time (e.g., as 2.5 msec at 15 kHz SCS and 1.25 msec at 30 kHz SCS). For certain applications or operating modes, such as XR, URLLC, etc., this delay is problematic and can affect operations and performance.

Additionally, the current SR and BSR scheme for reporting data in an uplink buffer may not satisfy planned latency or offer a good user experience. For example, the data in the UE buffer may have a certain duration of when the data is valid, valuable or desired by another device, such as a Twait time. The current reporting scheme may not satisfy one or more parameters (e.g., PDB or Twait) as many additional network operations may take place between 315 and 340. There may be multiple delays of a plurality of slots between each operation described in FIG. 3, and accordingly, the data at the UE may not be sent in time or reach its ultimate destination in time.

A BSR or BSR data may include or correspond to an amount of data stored in a buffer, such an amount of encoded data in an uplink buffer awaiting to be sent. BSR data may be indicated with reference indirectly (such as with reference to thresholds or ranges) as opposed to directly (e.g., an exact numerical value). The BSR data may have different sizes or resolutions (bit lengths), and may accommodate 150000 bytes or 81338368 for an 8-bit index (256 indexes) as illustrative, non-limiting examples. Twait may include or correspond to the waiting time for next available UL slot if the current slot is not UL slot. Additionally, or alternatively, Twait may include or correspond to the waiting time for next available DL slot if the current slot is not DL slot. The Packet Delay Budget (PDB) may include or correspond to (e.g., define) an upper bound for a time period or duration that a packet may be delayed between the UE and the user plane function (UPF) that terminates the N6 interface. The PDB parameter may have different characteristics for Guaranteed Bit Rate (GBR) or non-GBR operations.

In the aspects described here, enhanced buffered data information reporting operations and schemes are disclosed to reduce latency and enable faster UL operations which can offer a better user experience and satisfy the requirements of demanding reduced latency or emergency operational modes. In the aspects described herein, logical channel information which indicates for which logical channel or channels the UE should report buffered data information for, may be transmitted in a downlink transmission to the UE such that the UE can respond quicker to the base station with the buffered data information in a next or subsequent uplink resource or resources. That way, the UE will not experience a delay of waiting for a specific or dedicated UL grant to report the BSR and the UE can more flexibility include the buffered data information in currently or previously scheduled upcoming resources. Additionally, such schemes may reduce or provide a quick turnaround between gNB and UE for resource allocation.

Additionally, the aspects described herein can also reduce signaling overhead. For example, in some implementations, the separate SR and BSR can be removed or eliminated. To illustrate, the process for reporting buffered data information may start with receiving a control channel transmission (e.g., PDCCH including DCI) indicating one or more LC IDs and sending the buffered data information in one or more upcoming uplink resources assigned by the control channel transmission or already assigned to the UE. This may include in some implementations, actually sending the buffered data information in an upcoming SR or BSR after the control channel transmission without actually sending a SR or BSR to prompt the indication of the LC ID information for sending the buffered data information. Accordingly, the UE 115 may indicate it has data to send and actually send the data to the network faster and with reduced latency as compared to legacy BSR operations.

In the aspects described herein, the buffered data information and/or the reporting thereof can be utilize multiple formats, and each format may have different contents for the buffered data information and/or may use different reports and/or resources to report the buffered data information. Accordingly, the UE 115 and network may have further increased flexibility to report buffered data information (or portions thereof) in different reports and/or resources.

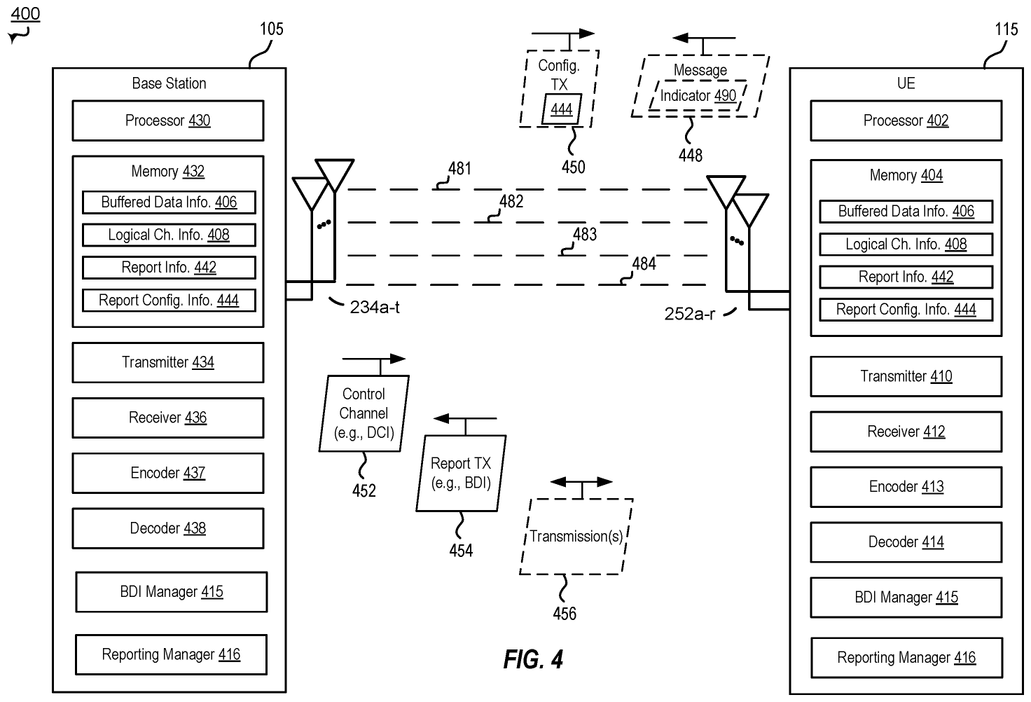

FIG. 4 illustrates an example of a wireless communications system 400 that supports enhanced buffered data information reporting in accordance with aspects of the present disclosure. In some examples, wireless communications system 400 may implement aspects of wireless communication system 100. For example, wireless communications system 400 may include a network, such as one or more network entities, and one or more UEs, such as UE 115. As illustrated in the example of FIG. 4, the network entity includes a corresponds to a base station, such as base station 105. Alternatively, the network entity may include or correspond to a different network device (e.g., not a base station).

Enhanced buffered data information reporting may reduce latency and failures, such as due to receipt of uplink data after it is valid. These improvements may reduce latency and increase throughput by improving connection quality and reducing retransmission of data and failures. Accordingly, network and device performance can be increased.

Base station 105 and UE 115 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, or a Bandwidth Part (BWP) ID. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management or BWP switching functionality. In some implementations, two or more CCs are quasi co-located, such that the CCs have the same beam and/or same symbol.

In some implementations, control information may be communicated via base station 105 and UE 115. For example, the control information may be communicated suing MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, buffered data information manager 415 (also referred to as BDI manager 415), reporting manager 416 (e.g., BDI reporting manager), and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store buffered data information data 406, logical channel information 408, report information 442, report configuration information 444, settings data, or a combination thereof, as further described herein.

The buffered data information 406 includes or corresponds to data associated with or corresponding to data (e.g., encoded or processed data) residing in an uplink buffer awaiting to be sent, and may be referred to as buffered data or BDI. For example, the buffered data information 406 may include an amount of data in the buffer (often associated with a BSR), a time or duration associated with the data in the buffer, a priority level of the data in the buffer, a logical channel identifier or group identifier of the data in the buffer, or a combination thereof. Each piece of buffered data information 406 may be associated with or for a particular logical channel. The time or duration of the buffered data information 406 may include or correspond to Twait, a packet delay budget (PDB), or another duration.

The buffered data information 406 may be included in or correspond to a SR request, a BSR, a delay status report (DSR), a statistical delay or delay status report (SDR), a priority or time information report, or a combination thereof. To illustrate, when the buffered data information 406 is included in or corresponds to a SR request, the SR request may include a request for certain LC IDs indicated in the DCI, and optionally indicate an amount of data in the buffer and/or a timing parameter indication for the LC IDs. When the buffered data information 406 is included in or corresponds to a BSR, the BSR may have a high or low resolution (e.g., as low as 1 bit) and indicate whether the BSR (e.g., amount of data in the buffer) is greater than a threshold for one or more of LC IDs provided in DCI. When the buffered data information 406 is included in or corresponds to a DSR, the DSR may have a high or low resolution (e.g., as low as 1 bit) and indicate whether the DSR (e.g., timing parameter, such as PDB or Twait) is greater than a threshold for one or more of LC IDs provided in DCI. When the buffered data information 406 is included in or corresponds to a SDR, the SDR may have a high or low resolution (e.g., as low as 1 bit) and indicate whether the SDR (e.g., delay statistic parameter, such as a DL delay, an UL delay, a PDB or Twait) is greater than a threshold for one or more of LC IDs provided in DCI.

When the buffered data information 406 is included in or corresponds to a parameter for one or more of the ongoing UL packets (e.g., active or scheduled), the parameter information may include a remaining PDB or a Twait information for the one or more of the ongoing UL packets. When the buffered data information 406 is included in or corresponds to a parameter for the LC IDs given in the DCI (e.g., scheduling DCI, the parameter information may include a remaining PDB or a Twait information for one or more of the LC IDs given in the DCI. The buffered data information 406 may include or be indicated by a bitmap in some implementations. For example, a type or types of buffered data information may be indicated by one or more bitmaps with reference to a threshold, such as threshold received in a buffered data information configuration transmission (e.g., control channel transmission 452 or first control channel transmission) or a triggering transmission (e.g., second control channel transmission). To illustrate, a value of 0 in the bitmap may indicate that a parameter (e.g., amount of buffered data, Twait, PDB, etc.) does not satisfy a corresponding threshold for a certain LC ID or LCG ID, and a value of 1 in the bitmap may indicate that a parameter (e.g., amount of buffered data, Twait, PDB, etc.) satisfies the corresponding threshold for a certain LC ID or LCG ID.

The buffered data information 406 may be included different types of uplink transmission resources. The buffered data information 406 may be sent in control channel resources, data channel resources, or a combination of data and control channel resources. For example, the buffered data information 406 may be sent in PUCCH resources. When sent in PUCCH resources, the buffered data information 406 may be sent in dedicated resources (e.g., previously assigned or dedicated periodic or semi-persistent resources) and/or one or more of SR resources/SR occasions, HARQ-ACK resources, CSI resources, etc. As another example, the buffered data information 406 may be sent in PUSCH resources. When sent in PUSCH resources, the buffered data information 406 may be sent in dedicated resources (e.g., previously assigned or dedicated periodic or semi-persistent resources) and/or CSI resources. When sent in both resources, the buffered data information 406 may be sent in a PUCCH resource and a PUSCH resource, such as a first portion of the buffered data information 406 may be sent in a PUCCH resource (e.g., SR or HARQ-ACK) and a second portion of the buffered data information 406 may be sent in a PUSCH resource or a different type of PUCCH resource. As illustrative examples, the buffered data information 406 may be sent in HARQ-ACK resource associated with a PDSCH (e.g., indicated in the DL DCI), new PUCCH resource indicated in the DCI, new PUSCH allocation indicated in the DL DCI (e.g., the DCI can activate a configured grant or dynamic grant to send the buffered data information 406.

Additionally, when a PUSCH is used to carry or report the buffered data information 406, the buffered data information 406 may be included in a layer 1 signal (PHY, PUSCH), a layer 2 signal (e.g., MAC CE), or a layer 3 signal (e.g., RRC).

In some implementations, the uplink resources are explicitly defined. For example, a UE 115 may use a certain type of uplink resource, or a next uplink resource, a second uplink resource, etc. Additionally, or alternatively, the UE 115 may use priority information and/or one or more conditions to resolve any priority conflicts or collisions with the buffered data information 406 and other UL data or channels. The priority information may define a priority for each type of buffered data information 406, each type of uplink data, each type of UL channel, each type of service, each layer, or a combination thereof. As an illustrative, non-limiting example, a network may provide layer 1 (L1) priority if a PUCCH is used using L1/L2/L3 indication or indicated by the DCI scheduling the buffered data information 406. Additionally, or alternatively, the network may provide layer 1 and/or layer 2 (L1/L2) priorities if a PUSCH is used using L1/L2/L3 indication or indicated by the DCI scheduling the buffered data information 406. To illustrate, the UE 115 may determine and use the priority of the logical channel with highest priorities as the priority of the buffered data information 406 (e.g., a report including the buffered data information 406). A priority of each quantity of the report (and a maximum priority within such quantities) can be used to define the final priority indicator of the report.

In some implementations, the number of the codepoints available in the DCI is less than a total number of LCHs. In some such implementations, the network will send multiple DCIs indicating the LCHs. In other such implementations, the network may indicate the LCHs indirectly, such as by an index value which points to set of logical channels in an index, or to a logical channel group (e.g., logical channel group ID).

The logical channel information 408 includes or corresponds to data associated with or corresponding to logical channels. For example, the logical channel information 408 may include or correspond to logical channel identifiers (LC IDs or LCIDs), logical channel group identifiers (LCG ID), or a combination thereof, and my indicate one or more logical channels, such as one or more logical channels to report the corresponding buffered data information 406. The logical channel information 408 may be indicated by a bitmap in some implementations. For example, the local channels (or LC IDs or LCG IDs) may be indicated by a bitmap. To illustrate, a value of 0 in the bitmap may indicate that the network is not requesting buffered data information (or a particular portion thereof) for a certain LC ID or LCG ID and a value of 1 in the bitmap may indicate that the network is requesting buffered data information (or a particular portion thereof) for a certain LC ID or LCG ID.

The report information 442 (e.g., BDI report or reporting information) includes or corresponds to data associated with or corresponding to BDI reports and BDI report transmissions. For example, the report information 442 may include or correspond to one or more BDI reports or one or more transmissions with portions of the buffered data information 406. A BDI report may include or be generated based on buffered data information 406, the logical channel information 408, or both. To illustrate, a BDI report may include, for each logical channel, an indication of an amount data in a buffer for a corresponding logical channel, an indication of a timing parameter (e.g., PDB/Twait) for a corresponding logical channel, or both. Additionally, or alternatively, the UE 115 may include other information in the report, such as priority information. In some implementations, the BDI report may be generated based on the priority information.

In some implementations, the report information 442 includes or corresponds to an aperiodic buffer information report, such as an aperiodic or dynamically trigger report which may include on or more of an aperiodic BSE, DSR, SDR, SR, etc. In such implementations, a timing of the aperiodic buffer information report is based on the timing of the DCI and may be indicated by the DCI, or configured by RRC and then determined based on DCI. The report information 442 (e.g., the aperiodic buffer information report) may be mixed with or jointly indicated with other types of information, such as with HARQ-ACK information.

The report configuration information 444 (e.g., BDI report or reporting configuration information) includes or corresponds to data indicating or corresponding to BDI report or reporting configurations. For example, the report configuration information 444 may include or correspond to report timing information, report type information, report format information, report history length, report resource information, report threshold information, reports per serving cell information, bandwidth part information, subband information, or a combination thereof.

The settings data includes or corresponds to data associated with enhanced buffered data information reporting operations. The settings data may include one or more types of enhanced buffered data information reporting operation modes and/or thresholds or conditions for switching between enhanced buffered data information reporting modes and/or configurations thereof. For example, the settings data may have data indicating different thresholds and/or conditions for different enhanced buffered data information reporting modes, such DL DCI scheduling modes, UL DCI scheduling modes, control DCI modes, feedback reporting modes, joint encoding modes, joint indication modes, etc., or a combination thereof.

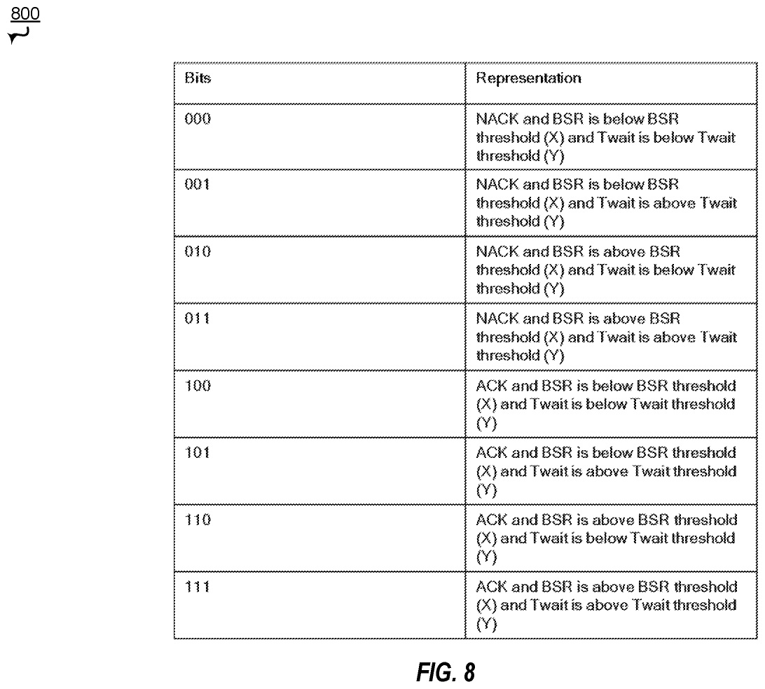

The UE 115 may further include other types of data, such as feedback information data, uplink resource information data, BDI condition information data (e.g., BSR thresholds or ranges, Twait thresholds or ranges, PDB thresholds or range, etc.), or a combination thereof. For example, feedback information data may indicate feedback for received downlink transmissions and may be multiplexed or encoded with buffered data information to create a joint indication. The uplink resource information data may include or correspond to uplink resources previously assigned to the UE 115, uplink resources newly assigned to or activated for the UE 115 in the transmission (e.g., DCI) including the logical channel information from the network, or a combination thereof, for the UE 115 to transmit (or consider transmitting) the buffered data information. The BDI condition information data may include thresholds or ranges used for reporting indications for buffered data information. Examples of such are described further with reference to FIG. 8.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410 or receiver, 412 may include or correspond to one or more components of UE 115 described with reference to FIG. 2.

Encoder 413 and decoder 414 may be configured to encode and decode data for transmission. BDI manager 415 may be configured to perform BDI determination and buffer management operations. For example, BDI manager 415 may be configured to determine and/or measure an amount of buffered data for BDI reporting. To illustrate, the BDI manager 415 may be configured to determine buffered data information 406, logical channel information 408, or both. Optionally, the BDI manager 415 may be configured to determine for which logical channels to report buffered data information, a priority of the buffered data information, a logical channel of the buffered data information, or a combination thereof.

Report manager 416 (e.g., BDI report manager) may be configured to perform BDI reporting operations, such as report configuration, report generation, and report transmission operations. For example, report manager 416 may be configured to generate the report information 442 based on the buffered data information 406, logical channel information 408, or both, according to a report configuration indicated by the report configuration information 444. Optionally, the report manager 416 may be configured to determine in which uplink resources (e.g., which uplink transmission or transmissions) to transmit the buffered data information 406 and/or the report information 442.

Although one UE is shown in the example of FIG. 4, in other implementation the network may include additional UEs. The other UE or UEs may include one or more elements similar to UE 115. In some implementations, the UE 115 and the other UE or UEs are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc.

Base station 105 includes processor 430, memory 432, transmitter 434, receiver 436, encoder 437, decoder 438, buffered data information manager 439, reporting manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store buffered data information 406, logical channel information 408, report information 442, report configuration information 444, settings data, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434 or receiver, 436 may include or correspond to one or more components of UE 115 described with reference to FIG. 2.

Encoder 437, and decoder 438 may include the same functionality as described with reference to encoder 413 and decoder 414, respectively. Buffered data information manager 439 may include similar functionality as described with reference to buffered data information manager 415. Reporting manager 439 may include similar functionality as described with reference to reporting manager 416.

During operation of wireless communications system 400, the network (e.g., base station 105) may determine that UE 115 has enhanced buffered data information reporting capability. For example, UE 115 may transmit a message 448 that includes an enhanced buffered data information reporting indicator 490 (e.g., an enhanced buffered data information capability indicator). Indicator 490 may indicate enhanced buffered data information reporting capability for one or more communication modes, such as downlink scheduling DCI, uplink scheduling DCI, control DCI (e.g., non-scheduling DCI), etc., or for a particular type of uplink resource (PUCCH, PUSCH, SR, BSR, DSR, CSI, HARQ-ACK, or a combination thereof). In some implementations, a network entity (e.g., a base station 105) sends control information to indicate to UE 115 that enhanced buffered data information reporting operation and/or a particular type of enhanced buffered data information reporting operation is to be used. For example, in some implementations, configuration transmission 450 is transmitted to the UE 115. The configuration transmission 450 may include or indicate to use enhanced buffered data information reporting operations or to adjust or implement a setting of a particular type of enhanced buffered data information reporting operation. For example, the configuration transmission 450 may include report configuration information 444, as indicated in the example of FIG. 4, settings data, or any combination thereof.

During operation, devices of wireless communications system 400 perform enhanced buffered data information reporting operations. For example, the network and UEs may exchange transmissions via uplink, downlink, and/or sidelink communications over the communication links and engage in enhanced buffered data information reporting as illustrated in the example of FIG. 4. This enhanced buffered data information reporting enables devices to more quickly notify the network of uplink data to be sent and ultimately send the data with reduced latency. The enhanced buffered data information reporting may be achieved by receiving logical channel information from the network and reporting the buffered data information in one or more uplink resources after receiving the logical channel information without first sending a SR or BSR. The buffered data information and corresponding reports may provide additional information for uplink operations, including support of joint indications for uplink data and buffered data information.

In the example of FIG. 4, the devices of the network may engage in one or more operations, such as first transmissions. For example, the base station 105 and the UE 115 may each transmit or receive a transmission or transmissions of the first transmissions. The operations of the devices of the network may cause devices of the network, such as UE 115, to generate uplink data to send to the network (including data for the network (e.g., base station 105) and other UEs of the network).

In the example of FIG. 4, the UE 115 generates uplink data associated with the operations performed with the base station 105. For example, the UE 115 (e.g., the BDI manager 415 thereof) determines buffered data information 406 based on one or more of the operations or first transmissions with the base station 105. The buffered data information 406 may include or correspond to data indicating an amount of data in an uplink buffer, indication data providing an indication with respect to one or more parameters (e.g., PDB, Twait, priority, etc.), or combination thereof.

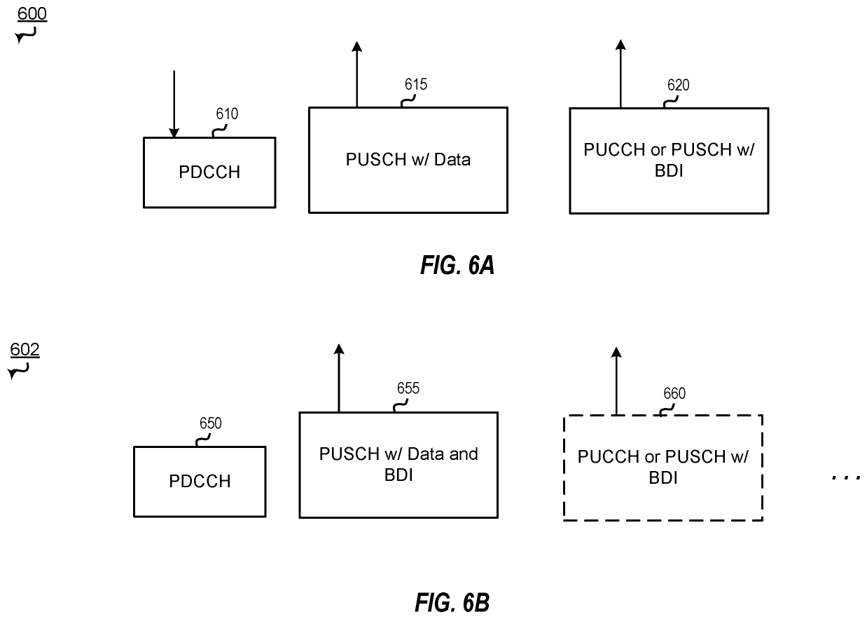

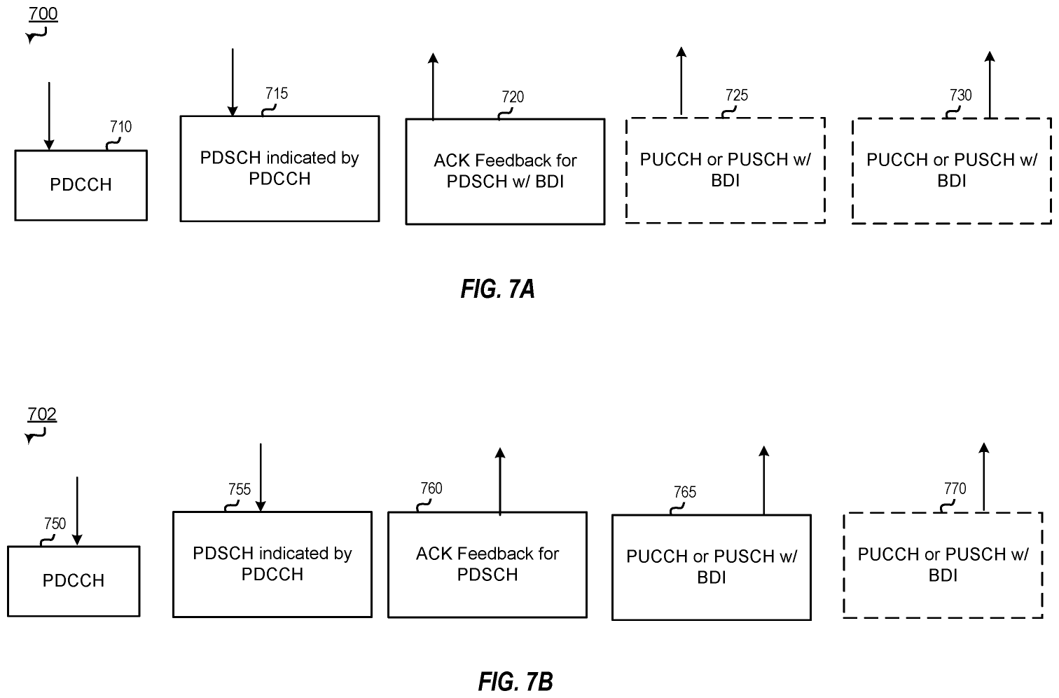

The base station 105 transmits a control channel transmission 452 to the UE 115 including logical channel information 408. The base station 105, such as the BDI manager 439 or reporting manager 440 thereof, may determine one or more logical channels it would like the UE 115 to report a buffer status or buffered data information for. For example, the base station 105 may generate the logical channels based on prior operations, prior SRs, prior BSRs, or prior instances of buffered data information from the UE 115. The base station 105 may indicate the logical channels (LCHs) using one or more index values, LC ID values or LCG ID values. To illustrate, the base station 105 may transmit a DCI in a PDCCH including the logical channel information 408, and optionally UL and/or DL resource information, as described further with respect to FIGS. 6A-7B. The control channel transmissions 452 may include or correspond to broadcast message, a RRC message, a DCI transmission, a PDCCH, a PDSCH, a PSCCH, a PSSCH, a SCI, a SL-MAC-CE, or a SL-RRC message. In some such implementations, the control channel transmission 452 includes the BDI condition information data, such as threshold or range information for one or more parameters reported in the reported in the buffered data information 406. To illustrate, the control channel transmission 452 may indicate a BSR or amount of data threshold of 10000 bytes, and the UE 115 may use a bitmap to indicate whether the BSR or amount of data for each logical channel is over or under the threshold of 10000 bytes when reporting the buffered data information 406.

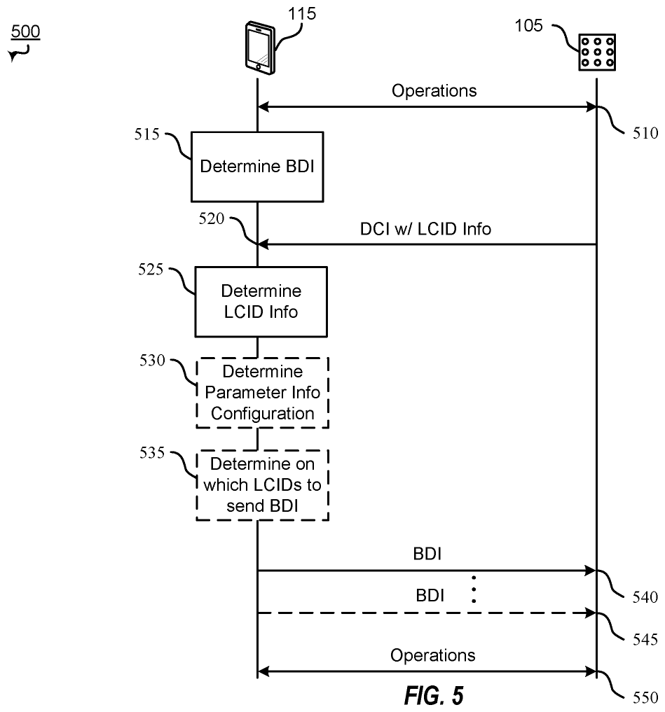

The UE 115 receives the control channel transmission 452, including the logical channel information 408, and determines to report buffered data information based on receiving the control channel transmission 452 including the logical channel information 408. The p UE 115 generates report information 442 based on the buffered data information 406 and/or the logical channel information 408, and the UE 115 transmits the report information 442 in a report transmission 454 (e.g., a BDI report transmission) to the base station 105. For example, the UE 115 reports buffered data information for one or more of the logical channels indicated by the logical channel information 408 in the report transmission 454. The report transmission 454 may include multiple BDI reports, and each BDI report may correspond to a particular logical channel of the logical channels indicated by the logical channel information 408. To illustrate, the UE 115 may report buffered data information per logical channel and/or logical channel group. The UE 115 may determine a configuration or layout of the report transmission 454 based on the report configuration information 444. Examples of report transmissions and report transmission schemes are described further with reference to FIGS. 5-11. The report transmission 454 may include or correspond a PUCCH, a PUSCH, a PSCCH, a PSSCH, MAC CE, or a RRC message. The report transmission 454 may be included in or indicated by layer 1, layer 2 or layer 3 signaling or multiplexed with layer 1, layer 2 or layer 3 signaling.

In some implementations, the UE 115 also receives another transmission prior to generating the report transmission 454. For example, the UE 115 may receive a second control channel transmission indicating the transmission resources for the report transmission 454, such as an aperiodic report transmission or trigger transmission. The second control channel transmission may be indicated by layer 1, layer 2 or layer 3 signaling. To illustrate, in some such implementations, the second control channel transmission is a DCI, such as second DCI. In other such implementations, the second control channel transmission is a MAC CE or RRC transmission.

Additionally or alternatively, the second control channel transmission indicates threshold information for reporting the buffered data information 406. For example, the second control channel transmission (e.g., DCI) may indicate BDI condition information data, such as threshold or range information for one or more parameters reported in the reported in the buffered data information 406. To illustrate, the second control channel transmission may indicate a BSR or amount of data threshold of 10000 bytes, and the UE 115 may use a bitmap to indicate whether the BSR or amount of data for each logical channel is over or under the threshold of 10000 bytes when reporting the buffered data information 406.

The base station 105 receives the report transmission 454. The base station 105, such as the BDI manager 439 thereof, may optionally determine to assign or grant one or more uplink resource to the UE 115 based on the report information 442 (e.g., the buffered data information 406 thereof) of the report transmission 454. For example, the base station 105 may parse the report transmission 454 (e.g., the report information 442/buffered data information 406 thereof) based on a report configuration indicated by the configuration transmission 450 and/or the report configuration information 444 to determine the buffered data information 406 for the logical channels indicated by the logical channel information 408. The base station 105 may then generate a transmission indicating or granting the determined uplink resource or resources for the UE 115. To illustrate, the base station 105 may transmit a DCI or MAC CE indicating or activating PUCCH and/or PUSCH resources for the UE 115 to send data transmission to the base station 105, where the data transmissions correspond to data stored in an uplink buffer and reported to the base station 105 in the buffered data information 406 in the report transmission 454.

After the UE 115 receives the uplink resource information for transmission of uplink data reported to the network in the buffered data information 406, the UE 115 may transmit one or more uplink transmissions to the base station 105 including the uplink data (e.g., portions thereof). To illustrate, the UE 115 may be assigned uplink resources for at least one logical channel of the one or more logical channels that the UE 115 reported buffered data information 406 for, and the UE 115 may transmit uplink data to the base station 105 for or on the at least one logical channel, such as in one or more PUCCHs and/or PUSCHs.

Accordingly, the network (e.g., the base station 105 and the UE 115) may be able to more efficiently and effectively indicate buffered data information to the network and transmit stored or buffered uplink data to the network, reducing latency and invalid (e.g., timed out) data transmissions. Reducing latency and invalid data transmissions through enhanced buffered data information reporting schemes may increase throughput and reduce latency, which may lead to better network operations. Accordingly, the network performance and experience may be increased due to the increases in speed and reductions in latency and errors.

Referring to FIG. 5, FIG. 5 is a timing diagram 500 illustrating a wireless communication system that supports enhanced buffered data information reporting according to one or more aspects. The example of FIG. 5 corresponds to an example of enhanced buffered data information reporting operations which may include UE side logical channel refinement for sending buffered data information or logical channel parameter/condition evaluation for sending buffered data information.

The example of FIG. 5 includes similar devices to the devices described in FIGS. 1, 2, and 4, such as a UE 115 a network entity (e.g., base station 105). The devices of FIG. 5 may include one or more of the components as described in FIGS. 2 and 4. In FIG. 5, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

At 510, the base station 105 and the UE 115 perform one or more uplink and/or downlink operations with each other. For example, at or prior to 510 the base station 105 and the UE 115 establish a Uu communication link (also referred to as Uu link or UL/DL link). To illustrate, the UE 115 may perform RRC, RACH, and/or connection establishment operations to establish (or re-establish) an uplink and downlink communication link with a node of a network, such as base station 105. In some implementations, the communication link may be established as part of a handover operation or through another UE. As illustrated in the example of FIG. 5, the base station 105 and UE 115 may send and receive data during the operations.

At 515, the UE 115 determines it has buffered data information to send to the network. For example, the UE 115 may encode uplink data to send and place the encoded uplink data in an uplink buffer. The UE 115 may evaluate the uplink buffer, assigned uplink resources, uplink data thresholds, or a combination thereof, to determine it has buffered data information to provide to the network. The data to send may include or correspond to data generate during or after the operations 510 and/or may include or correspond to a link, call or service that the UE 115 is participating in.

At 520, the base station 105 transmits a control channel transmission indicating logical channel information. For example, the base station 105 may generate and transmit a DCI including a logical channel indication or indications to the UE 115 which indicates one or more logical channel IDs directly or indirectly. For example, the base station 105 may indicate the logical channels explicitly in the transmission or the base station may encode logical channel data with reference to a table of LC IDs or LCG IDs at the UE. In some implementations, the logical channels are indicated by individual LC IDs. In other implementations, a set of logical channels are indicated by a LC group ID (LC GID).

As illustrated in the example of FIG. 5, the UE 115 does not send a SR or BSR after determining the buffered data information at 515 and prior to receiving the DCI at 520. As compared to the legacy operations of FIG. 3, the base station 105 may preempt a SR or BSR transmission by the UE 115 and the corresponding delay associated therewith.

At 525, the UE 115 may determine the logical channel information indicated in the control channel transmission. For example, the UE 115 may receive the DCI including the logical channel information 408 indicating one or more LC IDs for the transmission of buffered data information. The UE 115 parse the received DCI (e.g., the logical channel information 408 thereof) to determine the one or more logical channels for the transmission of buffered data information When a DCI is used to indicate the logical channels, the DCI may include or correspond to a scheduling DCI or a non-scheduling DCI, such as a control DCI. The scheduling DCI may indicate or scheduling one or more uplink resources (e.g., UL scheduling DCI) or schedule one or more downlink resources (e.g., DL scheduling DCI). As illustrative examples, the DCI may be sent in a PDCCH and may indicated uplink PUSCH resources for the UE or downlink PDSCH resources for the UE. A control DCI may not schedule any UL or DL resources and may just indicate a control setting or parameter, or an adjustment thereto. A non-scheduling DCI, does not schedule uplink or downlink resources and may provide some other indication or information. As illustrative, non-limiting examples, the control DCI or non-scheduling DCI may include or correspond to a wake-up signal (WUS) DCI (DCI Format 2-6) or a DL cancellation (preemption) DCI (DCI Format 2-1), an UL cancellation DCI (DCI Format 2-4), slot format indicator (SFI) DCI, etc. The control DCI or non-scheduling DCI may be broadcast or groupcast, or may be unicast.

At 530, the UE 115 optionally determines parameter information confirmations. For example, the UE 115 may receive parameter configuration information in the DCI or by prior RRC message. Alternatively, the parameter configuration information is pre-configured or set by a network or standard. The UE 115 may determine one or more thresholds of conditions for generating BDI indications or for reporting the BDI. To illustrate, the UE 115 may determine a resolution of the parameters it is supposed to report for the one or more logical channels based on the DCI, a prior RRC message, or both. As an illustrative example, the UE 115 may determine to report a 4 bit indication for BSR (e.g., use 4 bits to provide an indication relating to an amount of data in a buffer, such as below a first threshold, between first and second thresholds, between second and third thresholds, etc.) and a 1 bit indication for Twait, and optionally the specific thresholds or ranges for the indications. Accordingly, the UE 115 may provide additional information to the network regarding the BDI and/or logical channels and/or dynamically adjust thresholds.

At 535, the UE 115 may optionally determine whether to report buffered data information for the one or more logical channel information indicated in the control channel transmission. For example, the UE 115 may modify or adjust the list of logical channels indicated by the network. To illustrate, the UE may reduce or select a subset of logical channels of the one or more logical channels. As another illustration, the UE 115 may add logical channels to or swap other logical channels with the one or more logical channels indicated by the network. The UE 115 may select or refine the one or more logical channels to generate second logical channels for buffered data information reporting based on one or more thresholds or conditions associated with the parameters, availability of uplink resources, etc. For example, the base station may select ten logical channels and the UE 115 may be set to report the top five logical channels according to a particular parameter (e.g., amount of data, Twait, etc.) or parameters. Accordingly, the UE 115 may refine the set of logical channels to only report relevant or high priority information or to accommodate a particular amount of uplink bandwidth. Thus, the UE 115 may be able to reduce signaling overhead and/or reduce latency by enabling BDI or a portion of the BDI for certain logical channels to be reported with less delay.

At 540, the UE 115 transmits buffered data information to the base station 105. For example, the report manager 416 of the UE 115 may generate BDI report information based on the buffered data information 406 and logical channel information 408 and include the BDI report information (e.g., report information 442) in a BDI report transmission, and the UE 115 may transmit the BDI report transmission (e.g., report transmission 454) to the base station 105 in an uplink transmission. In some implementations, the UE 115 transmits the BDI report (or the buffered data information 406) to the base station 105 in a single transmission. In other implementations, the UE 115 may transmit the buffered data information 406 over multiple reports or transmissions. Examples of multiple transmission schemes are described further with reference to FIGS. 6A-7B and 9-10B.

The transmission of the buffered data information to the base station 105 optionally includes determining which uplink resources to transmit the buffered data information. For example, the UE 115 may perform one or more evaluations of conditions for determining in which uplink resource to send the buffered data information in. To illustrate, the UE 115 may use configuration settings, priority or delay information, along with uplink bandwidth information to determine in what uplink resource or resources to send the buffered data information in. Examples of determining which uplink resource or resources to use are described further with reference to FIGS. 6A-7B and 9-10B

At 545, the UE 115 optionally transmits another portion (e.g., a second portion, a third portion, etc.) of the buffered data information to the base station 105. For example, when the UE 115 only transmitted a portion (e.g., first portion) of the buffered data information to the base station 105 in a first uplink resource at 540, the UE 115 may transmit another portion (e.g., a second portion, a third portion, etc.) of the buffered data information to the base station 105 in another uplink resource (e.g., a second uplink resource, a third uplink resource, etc.). The uplink resources may include different type of uplink resources in some implementations or be the same type of uplink resource in other implementations. The types of uplink resources may include any of the uplink resources described with reference to FIG. 4. Specific examples of different uplink resource combinations for sending buffered data information are described further with reference to FIGS. 6A-7B and 9-10B. As an illustrative, non-limiting example, the buffered data information manager 415 of the UE 115 may transmit a second portion of buffered data information based on previously assigned resources, such as SR, BSR, DSR, etc.

At 550, The UE 115 and the base station 105 perform one or more uplink and/or downlink operations with each other. For example, the base station 105 assigns uplink resources to the UE 115 for the transmission of data corresponding to the buffered data information reported to the base station 105. To illustrate, the UE 115 may transmit one or more uplink transmissions, such as PUCCHs and/or PUSCHs, including the data in the buffer based on reporting the buffered data information for the data in the buffer.

In some implementations, the base station 105 may further determine to adjust buffered data information reporting operations based on the received buffered data information at 540 and optionally 545. For example, the base station 105 may determine to adjust a setting or parameter of buffered data information reporting prior to or after 550. To illustrate, the base station 105 may determine to adjust in what resources the buffered data information is sent, thresholds or conditions for sending the buffered data information in certain resources, thresholds or conditions for buffered data information withing other indications, thresholds or conditions for evaluating when to send buffered data information (e.g., Twait, PDB, etc.), whether the UE can adjust (e.g., add, remove or substitute logical channels), or which logical channel or logical channels are indicated/assigned to the UE 115.

The base station 105 may generate remediation information indicative of such adjustments to the buffered data information reporting process and transmit the remediation information to the UE 115. For example, the base station 105 may transmit remediation information indicating a particular configuration change for the UE 115. To illustrate, the base station 105 may transmit DCI, a MAC CE, or RRC signaling to indicate a configuration change for the buffered data information reporting at UE 115. The change may include a configuration adjustment or setting modification, such as a higher layer configuration or parameter, and as described further with reference to FIG. 4.

Accordingly, in the example of FIG. 5, devices of the network may be able to engage in enhanced buffered data information reporting responsive to logical channel information to reduce delays in reporting buffered data information and requesting uplink resources for the transmission of uplink data/encoded data in UE buffers.

FIGS. 6A-7B and 9-10B indicate examples of timing diagrams for one or more operations of FIGS. 4 and/or 5. As illustrated in FIGS. 6A-7B and 9-10B, downward pointing arrows indicate downlink transmissions from a network device to a UE, such as from base station 105 to UE 115, and upward pointing arrows indicate uplink transmissions from a UE to a network device, such as from UE 115 to base station 105.

Referring to FIGS. 6A and 6B, FIGS. 6A and 6B illustrate timing diagrams 600 and 602 each illustrating a wireless communication system that supports enhanced buffered data information reporting according to one or more aspects. The examples of FIGS. 6A and 6B correspond to other examples of enhanced buffered data information reporting operations. In the examples of FIGS. 6A and 6B, the downlink transmission which includes the logical channel information is an uplink scheduling DCI.

The examples of FIGS. 6A and 6B may be performed by devices similar to the devices described in FIGS. 1, 2, and 4, such as a UE 115 and a network entity (e.g., base station 105). The devices may include one or more of the components as described in FIGS. 2 and 4. These devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

During operation of the example of FIG. 6A, at 610, the base station 105 transmits a PDCCH indicating one or more logical channels for BDI, as described with reference to 452 of FIGS. 4 and 520 of FIG. 5. For example, the base station 105 transmits a DCI including logical channel information indicating one or more logical channels by LC ID or group ID for sending BDI. The UE 115 receives the PDCCH indicating the one or more logical channels for BDI and may determine which logical channels to send BDI for. The UE 115 may further determine one or more other items based on the logical channel information, as described with reference to 530 and/or 535 of FIG. 5. For example, the UE 115 may determine which uplink resources to send the BDI in based on the DCI, previous resource allocations, or a combination thereof. The DCI may indicate one or more uplink resources, such as one or more PUSCH resources for the UE 115. The previous resource allocations may include SR allocations, BSR allocations, previous uplink allocations (e.g., CG, SPS, etc.), feedback allocations (e.g., HARQ-ACK allocations), reporting allocations (e.g., BSR, DSR, etc.), or a combination thereof.

In the example of FIG. 6A, the PDCCH includes or corresponds to an uplink scheduling DCI which schedules a future PUSCH, such as the PUSCH of 615, which does not carry BDI. At 615, the UE 115 transmits a PUSCH in the uplink resources indicated by the PDCCH. For example, the UE 115 transmits a data transmission not including BDI and including previously reported or allocated uplink data in the transmission resources indicated by the DCI. The base station 105 receives the PUSCH in the uplink resources indicated by the DCI and may determine the data that the UE 115 sent. According to prior configuration or other signaling, the base station 105 does not expect BDI in the PUSCH, such as in PUSCHs scheduled by the DCI in the example of FIG. 6A.

At 620, the UE 115 transmits a PUCCH or PUSCH including the BDI, as described with reference to 454 of FIGS. 4 and 525 of FIG. 5. For example, the UE 115 transmits a control transmission or a data transmission including the BDI for the one or more logical channels. The control or data transmission may include or correspond to PUCCH resources indicated in UL DCI or a PUSCH allocation indicated in the UL DCI, i.e., DL DCI can activate a configured grant or dynamic grant to send the buffered data information.

Although not shown in the example of FIG. 6A, the UE 115 may transmit the BDI in multiple discrete or separate uplink transmission resources, such as a first UL resource, a second UL resource, etc. as described with reference to FIG. 4, and further described with reference to FIGS. 7A-11.

The base station 105 receives the transmission or transmissions including the BDI and may determine the BDI that the UE 115 has to send for the one or more indicated logical channels. The base station 105 may then determine which logical channel or channels to grant the UE 115 uplink resources for. The base station 105 may further generate and transmit uplink grants and/or uplink grant resources for the UE 115 based on the determined logical channels to grant uplink resources for (which was determined based on the reported BDI). The base station 105 may further determine to adjust one or more BDI reporting parameters, such as Twait, based on the BDI received. The base station 105 may perform actions similar to receiving a BSR when receiving the BDI.

During operation of the example of FIG. 6B, at 650, the base station 105 transmits a PDCCH indicating one or more logical channels for BDI, as described with reference to 452 of FIG. 4, 520 of FIGS. 5, and 610 of FIG. 6A.

Similar to the example of FIG. 6A, in the example of FIG. 6B, the PDCCH includes or corresponds to an uplink scheduling DCI which schedules a future PUSCH such as the PUSCH of 655. However, in the example of FIG. 6B, the PUSCH of 655 carries at least a portion of the BDI.

At 615, the UE 115 transmits a PUSCH in the uplink resources indicated by the DCI. For example, the UE 115 transmits a data transmission which includes data for previously reported or allocated uplink data and which further includes BDI. The base station 105 receives the PUSCH in the uplink resources indicated by the DCI and may determine the data and the BDI that the UE 115 sent. According to prior configuration or other signaling, the base station 105 expect at least a portion of the BDI in the PUSCH at 655, such as in a PUSCH or PUSCHs scheduled by the DCI in the example of FIG. 6B.

At 660, the UE 115 optionally transmits a PUCCH or PUSCH (e.g., second PUSCH) including a second portion of the BDI, as described with reference to 454 of FIGS. 4 and 525 of FIG. 5. For example, the UE 115 transmits a control transmission or a data transmission including a second portion of the BDI for the one or more logical channels. The second portion of the BDI may include or correspond to BDI for a subset of logical channels, a subset of BDI for each of logical channels, or a combination thereof. The second transmission may be the same type of transmission or a different type of transmission from the first transmission.

Although not shown in the example of FIG. 6B, the UE 115 may transmit the BDI in additional discrete or separate uplink transmission resources, such as a third UL resource, as described with reference to FIG. 4, and further described with reference to FIGS. 6A, 7A, and 7B.

The base station 105 receives the transmission or transmissions including the BDI and may determine the BDI that the UE has to send for the one or more indicated logical channels. The base station 105 may then determine which logical channel or channels to grant the UE 115 uplink resources for. The base station 105 may further generate and transmit uplink grants and/or uplink grant resources for the UE 115 based on the determined logical channels to grant uplink resources for (which was determined based on the reported BDI). The base station 105 may further determine to adjust one or more BDI reporting parameters, such as Twait, based on the BDI received. The base station 105 may perform actions similar to receiving a BSR when receiving the BDI.

As compared to the example of FIG. 6A where BDI is not sent in a PUSCH scheduled by the DCI, the example of FIG. of 6B, which enables at least a portion of the BDI to be sent in the PUSCH scheduled by the DCI, has less latency for sending the BDI and ultimately for transmitting any data corresponding thereto. However, the example of FIG. 6B may have more overhead, errors or latency penalties for the data of the PUSCH scheduled by the DCI as compared to the example of FIG. 6A.

Accordingly, in the examples of FIGS. 6A and 6B, devices of the network may be able to engage in enhanced buffered data information reporting responsive to logical channel information in an uplink scheduling DCI to reduce delays in reporting buffered data information and requesting uplink resources for the transmission of uplink data/encoded data in UE buffers.

Referring to FIGS. 7A and 7B, FIGS. 7A and 7B illustrate timing diagrams 700 and 7602 each depicting a wireless communication system that supports enhanced buffered data information reporting according to one or more aspects. The examples of FIGS. 7A and 7B correspond to other examples of enhanced buffered data information reporting operations. In the examples of FIGS. 7A and 7B, the downlink transmission which includes the logical channel information is a downlink scheduling DCI.

The example of FIG. 7 may be performed by devices similar to the devices described in FIGS. 1, 2, and 4, such as a UE 115 and a network entity (e.g., base station 105). The devices may include one or more of the components as described in FIGS. 2 and 4. In These devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

During operation of the example of FIG. 7A, at 710, the base station 105 transmits a PDCCH indicating one or more logical channels for BDI, as described with reference to 452 of FIG. 4, 520 of FIGS. 5, and 610, 650 of FIG. 6. For example, the base station 105 transmits a DCI including logical channel information indicating one or more logical channels by LC ID or group ID for sending BDI. The UE 115 receives the PDCCH indicating the one or more logical channels for BDI and may determine which logical channels to send BDI for. The UE 115 may further determine one or more other items based on the logical channel information, as described with reference to 530 and/or 535 of FIG. 5. For example, the UE 115 may determine which uplink resources to send the BDI in based on the DCI, previous resource allocations, or a combination thereof. The previous resource allocations may include SR allocations, BSR allocations, previous uplink allocations (e.g., CG, SPS, etc.), feedback allocations (e.g., HARQ-ACK allocations), reporting allocations (e.g., BSR, DSR, etc.), or a combination thereof.

In the example of FIG. 7A, the PDCCH includes or corresponds to a downlink scheduling DCI which schedules a future PDSCH, such as the PDSCH of 715. At 715, the UE 115 receives a PDSCH in the downlink resources indicated by the DCI. For example, the base station 105 transmits a data transmission for previously reported or allocated downlink data. The UE 115 receives the PDSCH in the downlink resources indicated by the DCI and may determine the data sent by the base station 105.

At 720, the UE 115 transmits a feedback information indicating the BDI for the one or more logical channels, as described with reference to 454 of FIGS. 4 and 525 of FIG. 5, and further with reference to FIG. 8. For example, the UE 115 transmits a control transmission (e.g., PUCCH) including HARQ-ACK feedback (e.g., a HARQ-ACK feedback transmission or feedback report) and including the BDI for the one or more logical channels. The feedback information may include or correspond to feedback information for the PDSCH at 715 and scheduled by the DCI at 710. According to prior configuration or other signaling, the base station 105 expects BDI in the feedback information and/or transmission, such as in feedback transmissions or information for the PDSCHs scheduled by the DCI in the example of FIG. 7A.

At 725, the UE 115 optionally transmits a PUCCH or PUSCH including a second portion of the BDI for the one or more logical channels, as described with reference to 454 of FIGS. 4 and 525 of FIG. 5. For example, the UE 115 transmits a control transmission or a data transmission including a second portion of the BDI for the one or more logical channels. The second portion of the BDI may include or correspond to BDI for a subset of logical channels, a subset of BDI for each of logical channels, or a combination thereof. The second transmission may be the same type of transmission or a different type of transmission from the first transmission.

At 730, the UE 115 optionally transmits a PUCCH or PUSCH including a third portion of the BDI for the one or more logical channels, as described with reference to 454 of FIGS. 4 and 525 of FIG. 5. For example, the UE 115 transmits a control transmission or a data transmission including a third portion of the BDI for the one or more logical channels. The third portion of the BDI may include or correspond to BDI for a subset of logical channels, a subset of BDI for each of logical channels, or a combination thereof. The third transmission may be the same type of transmission or a different type of transmission from the first transmission, the second transmission, or both.

The base station 105 receives the transmission or transmissions including the BDI and may determine the BDI that the UE has to send for the one or more indicated logical channels. The base station 105 may then determine which logical channel or channels to grant the UE 115 uplink resources for. The base station 105 may further generate and transmit uplink grants and/or uplink grant resources for the UE 115 based on the determined logical channels to grant uplink resources for (which was determined based on the reported BDI). The base station 105 may further determine to adjust one or more BDI reporting parameters, such as Twait, based on the BDI received. The base station 105 may perform actions similar to receiving a BSR when receiving the BDI.

During operation of the example of FIG. 7B, at 750, the base station 105 transmits a PDCCH indicating one or more logical channels for BDI, as described with reference to 452 of FIG. 4, 520 of FIG. 5, 610, 650 of FIGS. 6, and 710 of FIG. 7.

In the example of FIG. 7B, the PDCCH includes or corresponds to a downlink scheduling DCI which schedules a future PDSCH, such as the PDSCH of 755. At 755, the UE 115 receives a PDSCH in the downlink resources indicated by the DCI, as described with reference to 715 of FIG. 7A.

At 760, the UE 115 transmits feedback information which does not include the BDI. For example, the UE 115 transmits a control transmission (e.g., PUCCH) including HARQ-ACK feedback (e.g., a HARQ-ACK feedback transmission or feedback report). According to prior configuration or other signaling, the base station 105 does not expect BDI in the feedback information or feedback transmission, such as in feedback information or feedback transmission for the PDSCHs scheduled by the DCI in the example of FIG. 7B.

At 765, the UE 115 transmits a PUCCH or PUSCH including the BDI for the one or more logical channels, as described with reference to 454 of FIGS. 4 and 525 of FIG. 5. For example, the UE 115 transmits a control transmission or a data transmission including BDI for the one or more logical channels.

At 770, the UE 115 optionally transmits a PUCCH or PUSCH including a second portion of the BDI for the one or more logical channels, as described with reference to 454 of

FIGS. 4 and 525 of FIG. 5. For example, the UE 115 transmits a second transmission including the second portion of the BDI which may be a control transmission or a data transmission. The second portion of the BDI may include or correspond to BDI for a subset of logical channels, a subset of BDI for each of logical channels, or a combination thereof. The second transmission may be the same type of transmission or a different type of transmission from the first transmission.

Although not shown in the example of FIG. 7B, the UE 115 may transmit the BDI in additional discrete or separate uplink transmission resources, such as a third UL resource, as described with reference to FIG. 4 and FIG. 7A.

The base station 105 receives the transmission or transmissions including the BDI and may determine the BDI that the UE has to send for the one or more indicated logical channels. The base station 105 may then determine which logical channel or channels to grant the UE 115 uplink resources for. The base station 105 may further generate and transmit uplink grants and/or uplink grant resources for the UE 115 based on the determined logical channels to grant uplink resources for (which was determined based on the reported BDI). The base station 105 may further determine to adjust one or more BDI reporting parameters, such as Twait, based on the BDI received. The base station 105 may perform actions similar to receiving a BSR when receiving the BDI.

As compared to the example of FIG. 7B where BDI is not sent in a PUSCH scheduled by the DCI, the example of FIG. of 7A, which enables at least a portion of the BDI to be sent in the PUSCH scheduled by the DCI, has less latency for sending the BDI and ultimately for transmitting any data corresponding thereto. However, the example of FIG. 7A may have more overhead, errors or latency penalties for the data of the PUSCH scheduled by the DCI as compared to the example of FIG. 7B.

Accordingly, in the examples of FIGS. 7A and 7B, devices of the network may be able to engage in enhanced buffered data information reporting responsive to logical channel information in a downlink scheduling DCI to reduce delays in reporting buffered data information and requesting uplink resources for the transmission of uplink data/encoded data in UE buffers.

Referring to FIG. 8, FIG. 8 depicts a table 800 illustrating an example of incorporating BDI and feedback information into a single indication, such as single field or bit sequence, for enhanced buffered data information reporting according to one or more aspects. The example of FIG. 8 corresponds to an example of buffered data information reporting for reporting BDI in feedback transmissions, such as the feedback transmission 720, 760 of

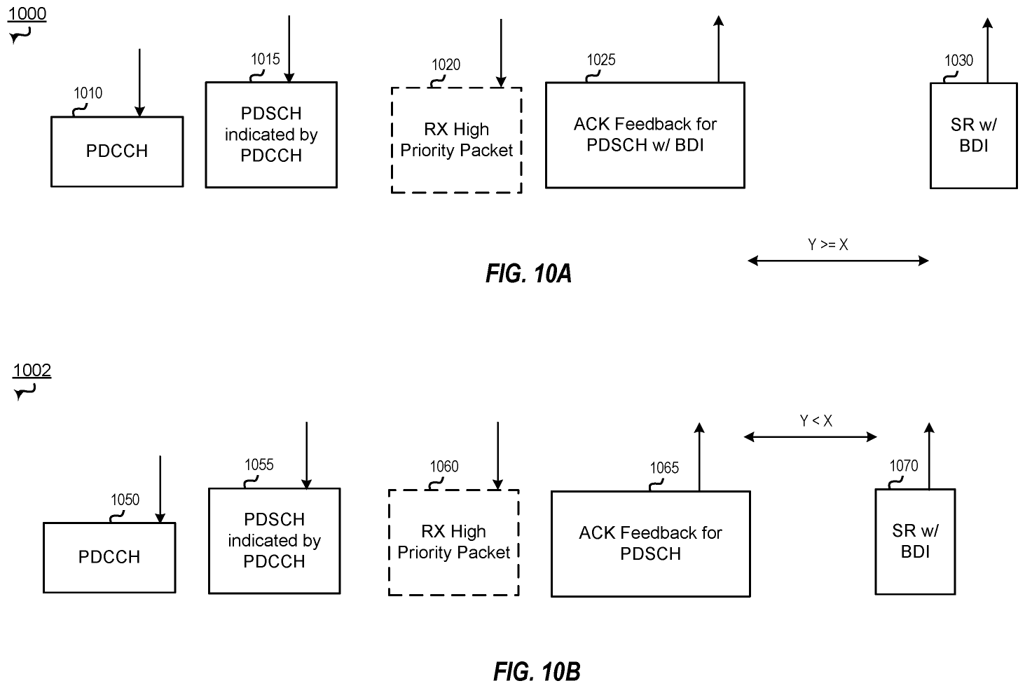

FIGS. 7A and 7B or the feedback transmissions described further with reference to FIGS. 10A and 10B. Although described with reference to feedback transmissions, BDI may be jointly indicated with other types of information in other implementations. As illustrative, non-limiting examples, the BDI may be jointly indicated with report information, such as BSR, CSI, DSR, or SDR reporting information. To illustrate, CSI of a CSI-RS report may be jointly indicated with BDI similar to the feedback information. As another illustration, delay status information may be jointly indicated with BDI similar to the feedback information.

In the example of FIG. 8, the table 800 has two columns and 8 rows (i.e., 2 to the third power). The columns represent a bit value indication for the first (left side) column and what is indicated by the bit value for the second (right side) column. The bit values correspond to three bit values from 000 to 111. A three bit value/three bit value field may be used to indicate multiple pieces of information, such as 8 pieces of information or 8 codepoints, or a series of three separate indications. In the example of FIG. 8, the three bit value/three bit value field indicates feedback information, BSR information (e.g., indication of amount of data in a buffer), and Twait information.

The example of FIG. 8 may be performed by similar devices to the devices described in FIGS. 1, 2, and 4, such as a UE 115 or a network entity (e.g., base station 105). These devices may include one or more of the components as described in FIGS. 2 and 4. These devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

As illustrated in FIG. 8, feedback information indications, such as the feedback information/indications of the HARQ-ACK transmission as in FIGS. 7A and 7B, may be combined with BDI indications to produce a joint indication, and the joint indications may indicate the feedback information and BDI information.

The feedback information may include or correspond to HARQ-ACK feedback information, such as a positive acknowledgement (e.g., ACK) or a negative acknowledgement (e.g., NACK). In some such implementations, a particular bit, such as the first, second or third bit may be used to indicate feedback information or indication. For example, when a particular bit of the sequence (e.g., the first) has a certain value a positive feedback or negative feedback indication is provided. To illustrate, when bit 1 has a value of 0, a NACK is indicated and when and when bit 1 has a value of 1 an ACK is indicated.

The BDI information may include or correspond to one or more parameters of a BSR. For example, the BDI may include an indication of an amount of data in the buffer for each logical channel indicated by the network. To illustrate, the data may be indicated explicitly, such as by a bit value representing the amount of data, such as a value of 11 to indicate 4 bytes of data, or may be indicated implicitly using an index and/or thresholds. When an index is used, index values may be used to indicate the amount of data in the buffer by using a table of values. Such as table and index may use or have threshold amounts or ranges of data as the values such that an index value indicated by the UE corresponds to a larger range of data values, such as over 1000 bytes or 2000 to 4000 bytes, etc. Examples of such indexes are may include BSR indexes for long or short formats as known in the art.

The BDI information may optionally include or correspond to a Twait parameter for each logical channel indicated by the network. To illustrate, a Twait value may be indicated explicitly or implicitly by the UE similar to the data in the buffer amount explained above. In the example of FIG. 8, the three bit sequence is used to indicate or convey Twait parameter information. In some such implementations, a particular bit, such as the second or third bit may be used to indicate the Twait parameter. For example, when a particular bit of the sequence (e.g., two or three) has a certain value a Twait indication is provided. To illustrate, when bit 3 has a value of 0, Twait is below a threshold and when bit 3 has a value of 1 Twait is above a threshold.

Adding additional bits provides more codepoints for the indication and optionally more resolution for the existing parameter and/or the ability to add additional parameters. For example, adding one additional bit enables additional (e.g., four) BSR or Twait thresholds to be used. As another example, adding one additional bit enables an additional parameter to be indicated, such as PDB information, operation type information (e.g., URLLC or eURLLC), priority level information, or another timing or QoS parameter. To illustrate, adding an additional bit enables PDB information or indications to be provided, such as if a PDB for each logical channel is above or below a PDB thresholds (e.g., a threshold PDB value). As adding one additional bit goes from 8 codepoints to 16 codepoints, the PDB indication may be provided for each combination of feedback indication, Twait indication, and amount of data indication.

Although specific bit values are associated with specific indications in the example of FIG. 8, in other implementations, which specific indications goes with which bit value may be arranged differently. The example of FIG. 8 is directed to implementations where HARQ-ACK feedback information of each PDSCH or bundle of PDSCHs can be used send buffered data information. As an illustrative example, the UE can at least send one bit related to each Twait/BSR of each LC ID provided in DCI being less or more than a threshold. Such implementations are compatible with PUCCH formats greater than type 0 where 11 bits or even more can be supported. The indications for the specific bit values of the bit sequence and the thresholds may be defined by RRC/MAC-CE (e.g., semi-static), may be DCI configured (e.g., dynamic), or can be stated in spec (e.g., static).

During operation a base station 105 (e.g., gNB) indicates a plurality of LC IDs in a DCI that it wants the UE 115 to report BSR and Twait indications, such as BSR being less than or greater than a threshold and Twait being less than or greater than a threshold, where the thresholds can be already configured using L1/L2/L3 or can be configured in that DCI itself.

The UE 115 compares BSR of each LC ID indicated in DCI to the threshold to determine whether the BSR is greater than the threshold and compares Twait of each LC ID indicated in DCI to the threshold to determine whether the Twait is greater than the threshold. The UE 115 may then send BSR indication information and Twait indication information for each LC ID. For example, the UE may send 1 bit for each of BSR and Twait for each LC ID, and the information can be provided in HARQ-ACK (e.g., with the 1 bit ACK/NACK indication. To illustrate, the bits for the BSR and Twait may be part of its own separate or dedicated field or flag, or it may be dedicated bit of a largest or joint bit sequence. The UE may alternatively joint encode the BSR and Twait indication information as indicated in the Table 800 of FIG. 8, where no specific bit explicitly corresponds to BSR or Twait, but where the individual codepoints of the bit sequence convey the BSR and Twait indication information.

Accordingly, in the example of FIG. 8, devices of the network may be able to engage in joint indication of other types of data with BDI, such as indications for feedback information and buffered data information, to enable enhanced and more flexible buffered data reporting, such as inclusion of buffered data information into additional message, reports, and/or uplink resources (e.g., BSR, DSR, SDR, HARQ-ACK, CSI, etc.).

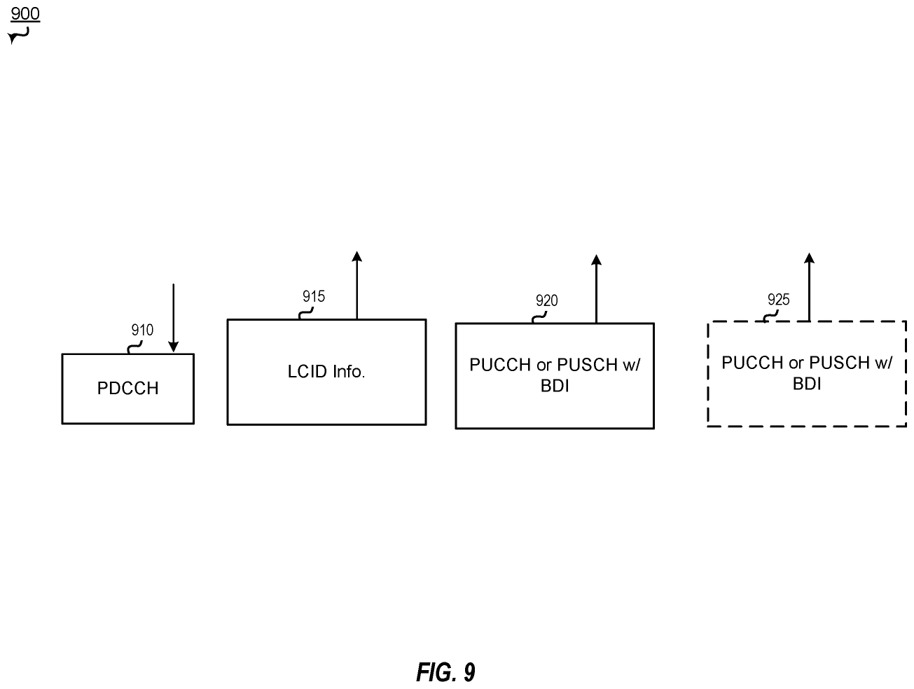

Referring to FIG. 9, FIG. 9 is a timing diagram 900 illustrating a wireless communication system that supports enhanced buffered data information reporting according to one or more aspects. The example of FIG. 9 corresponds to another examples of enhanced buffered data information reporting operations. In the example of FIG. 9, a UE engages in logical channel modification of the received logical channel information from the network.

The example of FIG. 9 may be performed by devices similar to the devices described in FIGS. 1, 2, and 4, such as a UE 115 and a network entity (e.g., base station 105). The devices may include one or more of the components as described in FIGS. 2 and 4. These devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

During operation of the example of FIG. 9, at 910, the base station 105 transmits a PDCCH indicating one or more logical channels for BDI, as described with reference to 452 of FIG. 4, 520 of FIG. 5, 610, 650 of FIGS. 6, and 710, 750 of FIG. 7. For example, the base station 105 transmits a DCI including logical channel information indicating one or more logical channels by LC ID or group ID for sending BDI. The UE 115 receives the PDCCH indicating the one or more logical channels for BDI and may determine which logical channels to send BDI for. The UE 115 may further determine one or more other items based on the logical channel information, as described with reference to 530 and/or 535 of FIG. 5. For example, the UE 115 may determine which uplink resources to send the BDI in based on the DCI, previous resource allocations, or a combination thereof. The previous resource allocations may include SR allocations, BSR allocations, previous uplink allocations (e.g., CG, SPS, etc.), feedback allocations (e.g., HARQ-ACK allocations), reporting allocations (e.g., BSR, DSR, SDR, etc.), or a combination thereof.

In the example of FIG. 9, the PDCCH may include or correspond to an uplink scheduling DCI as in the examples of FIGS. 6A and 6B, a downlink scheduling DCI as in the examples of FIGS. 7A and 7B, or a control DCI which does not schedule an uplink or downlink transmission.

At 915, the UE 115 transmits logical channel information (e.g., second logical channel information or logical channel modification information) to the base station 105 responsive to the PDCCH transmission including the logical channel information (e.g., first logical channel information). For example, the UE 115 transmits a PUCCH or PUSCH including second logical channel information, such as in the uplink resources indicated by the DCI or in a previously scheduled or allotted uplink transmission resources.

The second logical channel information includes or indicates a second set of one or more logical channels that is different from a first set of logical channels indicated by the logical channel information sent by the base station 105 at 910. For example, the UE 115 may select a subset of logical channels of the one or more logical channels and indicate that the UE 115 intends to report BDI for the subset of logical channels. Additionally or alternatively, the UE 115 may add a logical channel or channels to the one or more logical channels indicated by the base station 105 or swap out/change a logical channel or channels indicated by the base station 105 for an alternative channel. The base station 105 receives logical channel information and may determine a modification to at least one of the one or more logical channels indicated to the UE 115 at 910.

Although the second logical channel information that is sent from the UE 115 and described in the example of FIG. 9 includes or corresponds to logical channel modification information, in other implementations, the second logical channel information may include or correspond to logical channel parameter modification information. The logical channel parameter modification information may indicate a modification or adjustment to a parameter being reported in the BDI for each logical channel or a subset of logical channels or to a modification or adjustment to a parameter threshold for a parameter being reported in the BDI for each logical channel or a subset of logical channels. In some such implementations, the second logical channel information includes logical channel modification information and logical channel parameter modification information.

At 920, the UE 115 transmits an uplink transmission including or indicating the BDI for the one or more logical channels indicated in the second logical channel information sent by the UE 115 at 915, as described with reference to 454 of FIGS. 4 and 525 of FIG. 5, and further with reference to FIG. 8. For example, the UE 115 transmits a control transmission (e.g., PUCCH) or a data transmission (e.g., PUSCH) including the BDI for the modified one or more logical channels (e.g., a subset of logical channels of the one or more logical channels).

In some implementations, the DCI schedules the control transmission (e.g., PUCCH) or the data transmission (e.g., PUSCH) sent at 920, as described in the example of FIG. 6B. In other implementations, the DCI schedules an uplink transmission (which does not includes a portion of the BDI) prior to the uplink transmission at 920, as described with reference to FIG. 6A. Thus, the uplink transmission at 920 may be a second PUCCH or second PUSCH in some such implementations.

In other implementations, the DCI schedules a downlink transmission (not shown), as in the examples of FIG. 7A and 7B. In some such implementations, the transmission includes or corresponds to a HARQ-ACK feedback transmission report and includes feedback information along with the BDI for the modified one or more logical channels, as described with reference to FIGS. 7A, 7B, and 8.

In any of the above implementations or examples, a portion of the BDI may be included with the second logical channel information sent by the UE 115 at 915. Thus, in such implementations, the uplink transmission at 920 may be a second PUCCH/PUSCH or third PUCCH/PUSCH and/or have a second portion of the BDI for the modified one or more logical channels.

At 925, the UE 115 optionally transmits another uplink transmission (e.g., PUCCH or PUSCH) including a second portion of the BDI for the one or more logical channels, as described with reference to 454 of FIGS. 4 and 525 of FIG. 5. For example, the UE 115 transmits a control transmission or a data transmission including BDI for the modified one or more logical channels. In some other implementations, such as where a first portion of the BDI for the modified one or more logical channels was sent in the uplink transmission which includes the second logical channel information from the UE 115, the uplink transmission at 925 may include a third portion of the BDI for the modified one or more logical channels.

Although not shown in the example of FIG. 9, the UE 115 may transmit the BDI in additional discrete or separate uplink transmission resources, such as a third or fourth UL resource, etc. as described with reference to FIGS. 4-7B, and further described with reference to FIGS. 10A and 10B.

The base station 105 receives the transmission or transmissions including the BDI and may determine the BDI that the UE has to send for the modified one or more logical channels. The base station 105 may then determine which logical channel or channels to grant the UE 115 uplink resources for. The base station 105 may further generate and transmit uplink grants and/or uplink grant resources for the UE 115 based on the modified logical channels to grant uplink resources for (which was determined based on the reported BDI). The base station 105 may further determine to adjust one or more BDI reporting parameters, such as Twait, based on the BDI received. The base station 105 may perform actions similar to receiving a BSR when receiving the BDI.

Accordingly, in the example of FIG. 9, devices of the network may be able to engage in enhanced buffered data information reporting with logical channel modification responsive to logical channel information in a DCI to reduce delays in reporting buffered data information and requesting uplink resources for the transmission of uplink data/encoded data in UE buffers.

Referring to FIGS. 10A and 10B, FIGS. 10A and 10B each illustrate a timing diagram 1000 and 1002 depicting a wireless communication system that supports enhanced buffered data information reporting according to one or more aspects. The examples of FIGS. 10A and 10B correspond to other examples of enhanced buffered data information reporting operations. In the examples of FIGS. 10A and 10B, the downlink transmission which includes the logical channel information is a downlink scheduling DCI and the UE 115 uses conditions (e.g., timing or delay conditions) to devalue which uplink resources should be used to report the buffered data information.

The examples of FIGS. 10A and 10B may be performed by devices similar to the devices described in FIGS. 1, 2, and 4, such as a UE 115 and a network entity (e.g., base station 105). The devices may include one or more of the components as described in FIGS. 2 and 4. These devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

During operation of the example of FIG. 10A, at 1010, the base station 105 transmits a PDCCH indicating one or more logical channels for BDI, as described with reference to 452 of FIG. 4, 520 of FIG. 5, 610, 650 of FIG. 6, 710, 750 of FIGS. 7 and 910 of FIG. 9. For example, the base station 105 transmits a DCI including logical channel information indicating one or more logical channels by LC ID or group ID for sending BDI. The UE 115 receives the PDCCH indicating the one or more logical channels for BDI and may determine which logical channels to send BDI for. The UE 115 may further determine one or more other items based on the logical channel information, as described with reference to 530 and/or 535 of FIG. 5. For example, the UE 115 may determine which uplink resources to send the BDI in based on the DCI, previous resource allocations, or a combination thereof. The previous resource allocations may include SR allocations, BSR allocations, previous uplink allocations (e.g., CG, SPS, etc.), feedback allocations (e.g., HARQ-ACK allocations), reporting allocations (e.g., BSR, DSR, etc.), or a combination thereof.

In the example of FIG. 10A, the PDCCH includes or corresponds to a downlink scheduling DCI which schedules a future PDSCH, such as the PDSCH of 1015 and similar to the examples of FIGS. 7A and 7B. At 1015, the UE 115 receives a PDSCH in the downlink resources indicated by the DCI. For example, the base station 105 transmits a data transmission for previously reported or allocated downlink data. The UE 115 receives the PDSCH in the downlink resources indicated by the DCI and may determine the data sent by the base station 105.

Optionally, in some implementations the PDSCH at 1015 includes an arrived packet for or from a particular LC ID (e.g., LC ID X) which has higher priority than current data at the UE 115. The higher priority may be indicated by a lower PDB, lower Twait, higher data priority, mode, and/or QoS, or a combination thereof. Additionally, or alternatively, the UE 115 receives the arrived packet or another arrived packet, at 1020 after the PDSCH at 1015 and prior to transmission of the BDI, where the arrived packet or the other arrived packet is for or from a particular LC ID (e.g., LC ID X) which has higher priority than current data at the UE 115.

After the UE 115 receives the PDSCH in the downlink resources indicated by the DCI, the UE 115 may determine feedback resources for transmitting feedback for the PDSCH as described with reference to FIGS. 7A and 7B. In the examples of FIGS. 10A and/or 10B, the UE 115 may evaluate a condition for determining whether to include BDI in the feedback information or transmission for the PDSCH at 1015. To illustrate, the UE 115 may evaluate a timing condition for inclusion of the BDI in the feedback transmission based on a timing of the feedback transmission, a timing of a next uplink transmission (e.g., as next SR transmission), or both.

In the example of FIG. 10A, the UE 115 may determine whether a next SR occasion after the feedback transmission is more than a threshold amount of time from the feedback transmission (or from the PDCCH or the PDSCH). The threshold amount of time may be in terms of symbols, slots, or time units (e.g., milliseconds), and may be RRC, MAC-CE, or DCI configured. To illustrate, if the next SR occasion is more than X slots from the HARQ-ACK transmission for the PDSCH, the UE 115 may include the BDI (or at least a portion thereof) in the HARQ-ACK transmission for the PDSCH, such as the HARQ-ACK at 1025.

At 1025, the UE 115 transmits a feedback information indicating the BDI for the one or more logical channels, as described with reference to 454 of FIG. 4, 525 of FIG. 5, 725 of FIG. 7A, and 765 of FIG. 7B. For example, the UE 115 transmits a control transmission (e.g., PUCCH) including HARQ-ACK feedback (e.g., a HARQ-ACK feedback transmission or feedback report) and including the BDI for the one or more logical channels. The feedback information may include or correspond to feedback information for the PDSCH at 1015, which was scheduled by the DCI at 1010, and optionally feedback information for the second PDSCH at 1020. According to prior configuration or other signaling, the base station 105 expects BDI in the feedback information and/or transmission, such as in feedback transmissions or information for the PDSCHs scheduled by the DCI, based on one or more timing conditions in the example of FIG. 10A. Additionally, or alternatively, the base station 105 may expect or not expect BDI in the feedback transmission based on the UE receiving packet with a higher priority than current data.

In some implementations, such as when the UE 115 received a packet for or from a particular LC ID (LC ID x) that has higher priority than current data at UE, the UE 115 may report the BDI for the particular LC ID (LC ID x) first and/or prior to reporting BDI for the one or more logical channels (or the other logical channels of the one or more logical channels if the particular logical channel is part of the one or more logical channels. In some such implementations, only the particular LC ID is reported in the feedback transmission and the rest of the logical channels of the one or more logical channels are reported in another, subsequent uplink transmission.

At 1030, the UE 115 optionally transmits a SR including a second portion of the BDI for the one or more logical channels, as described with reference to 454 of FIGS. 4 and 525 of FIG. 5, 725 of FIG. 7A, and 775 of FIG. 7B. For example, the UE 115 transmits a control transmission including a SR that includes a second portion of the BDI for the one or more logical channels.

Although not shown in the example of FIG. 10A, the UE 115 may transmit the BDI in additional discrete or separate uplink transmission resources, such as a third UL resource, as described with reference to FIG. 7A and 7B.

The base station 105 receives the transmission or transmissions including the BDI and may determine the BDI that the UE has to send for the one or more indicated logical channels. The base station 105 may then determine which logical channel or channels to grant the UE 115 uplink resources for. The base station 105 may further generate and transmit uplink grants and/or uplink grant resources for the UE 115 based on the determined logical channels to grant uplink resources for (which was determined based on the reported BDI). The base station 105 may further determine to adjust one or more BDI reporting parameters, such as Twait, based on the BDI received. The base station 105 may perform actions similar to receiving a BSR when receiving the BDI.

During operation of the example of FIG. 10B, at 1050, the base station 105 transmits a PDCCH indicating one or more logical channels for BDI, as described with reference to 452 of FIG. 4, 520 of FIG. 5, 610, 650 of FIG. 6A and 6B, 710, 750 of FIGS. 7A and 7B, 910 of FIGS. 9, and 1010 of FIG. 10A.

In the example of FIG. 10B, the PDCCH includes or corresponds to a downlink scheduling DCI which schedules a future PDSCH, such as the PDSCH of 1055 and similar to the examples of FIGS. 7A, 7B, and 10A. At 1055, the UE 115 receives a PDSCH in the downlink resources indicated by the DCI. For example, the base station 105 transmits a data transmission for previously reported or allocated downlink data. The UE 115 receives the PDSCH in the downlink resources indicated by the DCI and may determine the data sent by the base station 105.

Optionally, in some implementations the PDSCH at 1015 includes an arrived packet for or from a particular LC ID (e.g., LC ID X) which has higher priority than current data at the UE 115. The higher priority may be indicated by a lower PDB, lower Twait, higher data priority, mode, and/or QoS, or a combination thereof. Additionally, or alternatively, the UE 115 receives the arrived packet or another arrived packet, at 1060 after the PDSCH at 1055 and prior to transmission of the BDI, where the arrived packet or the other arrived packet is for or from a particular LC ID (e.g., LC ID X) which has higher priority than current data at the UE 115.

After the UE 115 receives the PDSCH in the downlink resources indicated by the DCI, the UE 115 may determine feedback resources for transmitting feedback for the PDSCH as described with reference to FIGS. 7A, 7B, and 10A. In the examples of FIGS. 10A and/or 10B, the UE 115 may evaluate a condition for determining whether to include BDI in the feedback information or transmission at 1060 for the PDSCH at 1055 (and optionally the second PDSCH at 1060). To illustrate, the UE 115 may evaluate a timing condition for inclusion of the BDI in the feedback transmission based on a timing of the feedback transmission, a timing of a next uplink transmission (e.g., as next SR transmission), or both.

In the example of FIG. 10B, the UE 115 may determine whether a next SR occasion after the feedback transmission is more than a threshold amount of time from the feedback transmission (or from the PDCCH or the PDSCH). The threshold amount of time may be in terms of symbols, slots, or time units (e.g., milliseconds), and may be RRC, MAC-CE, or DCI configured. To illustrate, if the next SR occasion is more than X slots from the HARQ-ACK transmission for the PDSCH, the UE 115 may include the BDI (or at least a portion thereof) in the HARQ-ACK transmission for the PDSCH, such as the HARQ-ACK at 1025.

At 1065, the UE 115 transmits a feedback information to the base station 105, as described with reference to 454 of FIG. 4, 525 of FIGS. 5, and 765 of FIG. 7B. For example, the UE 115 transmits a control transmission (e.g., PUCCH) including HARQ-ACK feedback (e.g., a HARQ-ACK feedback transmission or feedback report) for one or more PDSCHs. The feedback information may include or correspond to feedback information for the

PDSCH at 1055, which was scheduled by the DCI at 1050, and optionally feedback information for the second PDSCH at 1060. According to prior configuration or other signaling, the base station 105 does not expects BDI in the feedback information and/or transmission, such as in feedback transmissions or information for the PDSCHs scheduled by the DCI, based on one or more timing conditions in the example of FIG. 10B. To illustrate, an amount of slots between the feedback transmission (Y) is less than the threshold amount of slots (X) in the example of FIG. 10B. Thus, the UE 115 may determine it has to wait until the next uplink transmission resource or next SR to send the BDI. Additionally, or alternatively, the base station 105 may expect or not expect BDI in the feedback transmission based on the UE receiving packet with a higher priority than current data.

At 1070, the UE 115 transmits a SR including the BDI for the one or more logical channels, as described with reference to 454 of FIGS. 4 and 525 of FIGS. 5, and 725 of FIG. 7A. For example, the UE 115 transmits a control transmission including a SR that includes at least a portion of the BDI for the one or more logical channels. When the SR includes only a portion of the BDI (e.g., a first portion of the BD), the second and potentially later portions are sent in future, subsequent uplink transmissions, not shown but described with reference to FIG. 7A, 7B, and 10A.

In some implementations, such as when the UE 115 received a packet for or from a particular LC ID (LC ID x) that has higher priority than current data at UE, the UE 115 may report the BDI for the particular LC ID (LC ID x) first and/or prior to reporting BDI for the one or more logical channels (or the other logical channels of the one or more logical channels if the particular logical channel is part of the one or more logical channels. In some such implementations, only the particular LC ID is reported in the SR transmission and the rest of the logical channels of the one or more logical channels are reported in another, subsequent uplink transmission (e.g., a next PUCCH or PUSCH).

The base station 105 receives the transmission or transmissions including the BDI and may determine the BDI that the UE has to send for the one or more indicated logical channels. The base station 105 may then determine which logical channel or channels to grant the UE 115 uplink resources for. The base station 105 may further generate and transmit uplink grants and/or uplink grant resources for the UE 115 based on the determined logical channels to grant uplink resources for (which was determined based on the reported BDI). The base station 105 may further determine to adjust one or more BDI reporting parameters, such as Twait, based on the BDI received. The base station 105 may perform actions similar to receiving a BSR when receiving the BDI.

Accordingly, in the examples of FIGS. 10A and 10B, devices of the network may be able to engage in delay or timing based condition evaluation for uplink resource determination for enhanced buffered data information reporting responsive to logical channel information in a downlink scheduling DCI to reduce delays in reporting buffered data information and requesting uplink resources for the transmission of uplink data/encoded data in UE buffers.

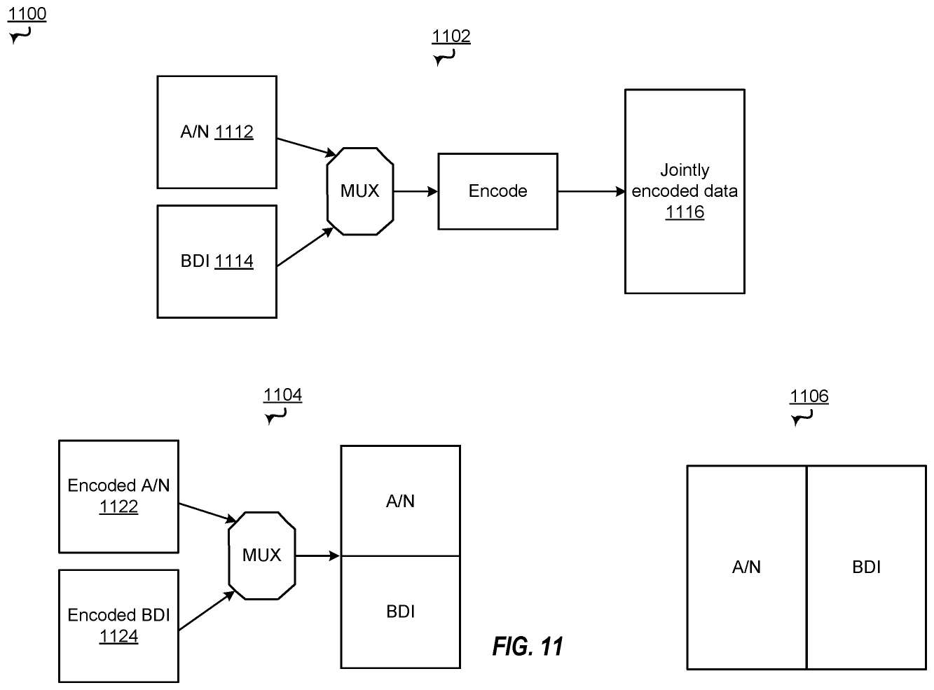

Referring to FIG. 11, FIG. 11 is a block diagram 1100 illustrating encoding examples for enhanced buffered data information reporting according to one or more aspects. The example of FIG. 11 corresponds to examples of multiplexing buffered data with other information, and specifically to examples of joint encoding and of multiplexing after encoding.

The example of FIG. 11 may be performed by similar devices to the devices described in FIGS. 1, 2, and 4-10, such as a UE 115 and/or a network entity (e.g., base station 105). The devices may include one or more of the components as described in FIGS. 2 and 4. These devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

Block diagram 1102 is an example of operations for joint encoding feedback information 1112 and BDI 1114. In the block diagram 1102, the feedback information 1112 and the BDI 1114 are multiplexed (at the MUX) to generate multiplexed data, and then the multiplexed data is jointly encoded to generate jointly encoded data 116, which is assigned to time and/or frequency resources as shown in the block diagram 1102.

In some implementations of the block diagram 1102, the raw or unencoded (not radio antenna encoded) feedback information 1112 and BDI 1114 are multiplexed or joined together, such as by concatenation, interlacing, indexing, encoding, etc., and the multiplexed joint data is then encoded for wireless transmission, such by a precoder or encoder or a radio front end unit. The encoding for wireless transmission after multiplexing may include or correspond to polar encoding, shift encoding (e.g., cyclic shift encoding, ASK, FSK, PSK, etc.), or sequence based encoding (e.g., encoding in a sequence based on a joint codepoint). As described with reference to FIG. 8, the table 800 is an example of joint indication and may be generated as part of the multiplexing of the block diagram 1102 FIG. 11.

Block diagrams 1104 and 1106 are examples of multiplexing the feedback information 1112 and the BDI 1114 in a single transmission by assigning each of the feedback information 1112 and the BDI 1114 to different (e.g., discreate and/or separate) transmission resources. Each of the feedback information 1112 and the BDI 1114 may be separately encoded to generate encoded feedback information 1122 and encoded BDI 1124, and then assigned to different time and or frequency resource allocations, or different resource elements or resource blocks, as shown in the block diagram 1104.

In the block diagram 1104, the feedback information 1112 and the BDI 1114 are each separately encoded and the encoded feedback information 1122 and the encoded BDI 1124 are assigned to different frequency resources at a same time (same time resources) to multiplex the encoded feedback information 1122 and the encoded BDI 1124.

In the block diagram 1106, the feedback information 1112 and the BDI 1114 are each separately encoded and the encoded feedback information 1122 and the encoded BDI 1124 are assigned to the same frequency resources at different times (different time resources) to multiplex the encoded feedback information 1122 and the encoded BDI 1124.

Additionally, or alternatively, one or more operations of FIGS. 3, 4, 5, 6A, 6B, 7A, 7B, 8, 9, 10A, 10B, and 11, may be added, removed, substituted in other implementations. For example, in some implementations, a UE may provide a joint indication as in FIG. 8 and may multiplex the data and BDI as in FIG. 11. As another example, a UE may select additional logical channels or modify logical channels as in FIGS. 5 and 9, and may report using any of the schemes of FIGS. 4, 6A, 6B, 7A, 7B, 10A, or 10B.

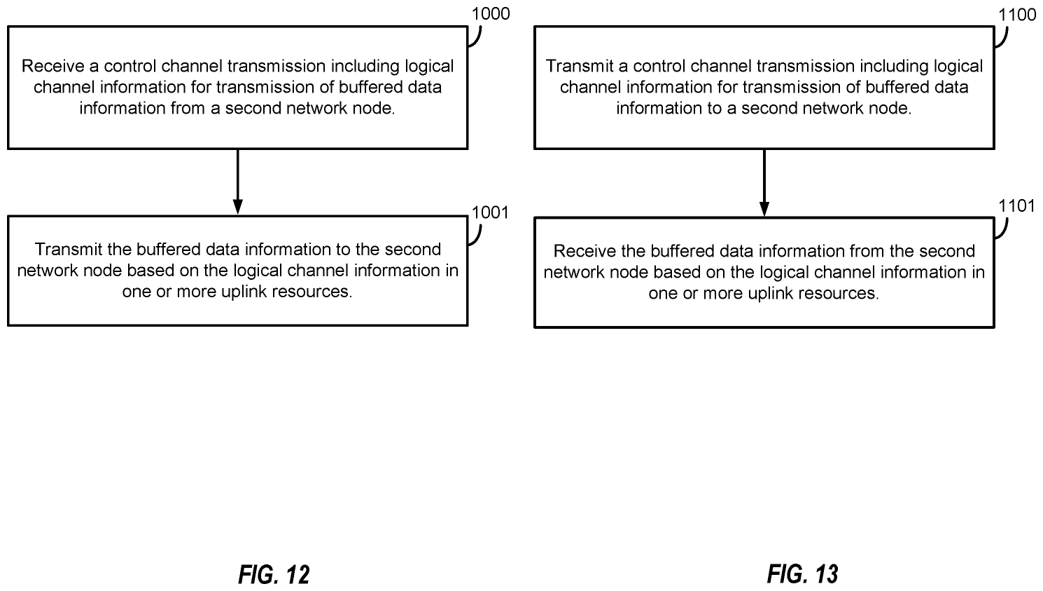

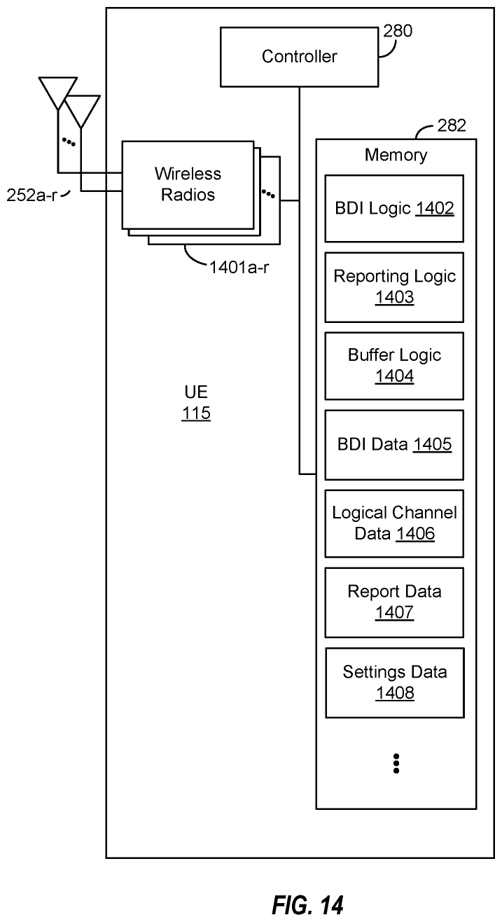

FIG. 12 is a flow diagram illustrating example blocks executed by a wireless communication device (e.g., a UE or base station) configured according to an aspect of the present disclosure. The example blocks will also be described with respect to UE 115 as illustrated in FIG. 14. FIG. 14 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1401a-r and antennas 252a-r. Wireless radios 1401a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 14, memory 282 stores BDI logic 1402, reporting logic 1403, buffer logic 1404, BDI data 1405, logical channel data 1406, report data 1407, and settings data 1408. The data (1402-1408) stored in the memory 282 may include or correspond to the data (406, 408, 442, and/or 444) stored in the memory 404 of FIG. 4.

At block 1200, a wireless communication device, such as a UE, receives a control channel transmission including logical channel information for transmission of buffered data information from a second network node. The control channel transmission may include or correspond to one or more of the control channel transmission 452 of FIG. 4, the DCI with LC IDs at 520 of FIG. 5, or the PDCCH transmissions of FIGS. 6A-10B. The logical channel information may include or correspond to including logical channel information 408 of FIG. 4. For example, the UE (e.g., UE 115) may receive a control channel transmission 452 or DCI from the base station 105 including logical channel information 408. To illustrate, UE 115 receives a DCI via wireless radios 1401a-r and antennas 252a-r and including logical channel information 408 indicating one or more LC IDs or LCG IDs.

At block 1201, the UE transmits the buffered data information to the second network node based on the logical channel information in one or more uplink resources. The buffered data information may include or correspond to one or more of the buffered data information 406 of FIG. 4, the report transmission 454, as described with reference to FIG. 4, or the BDI transmissions of FIGS. 5-10B. For example, the UE 115 may transmit buffered data information to a network device, such as base station 105. To illustrate, a transmitter (e.g., transmit processor 264 or transmitter 410) of the UE 115 transmits the report transmission 454 via wireless radios 1401a-r and antennas 252a-r including or indicating the buffered data information 406. As illustrative examples, the buffered data information may include or correspond to one or more indications for BSR/an amount of buffered data, Twait, a PDB, etc., and may be included in a report, such as included in or with report information 442. The report transmission 454 may include or correspond to any of the reports described with reference to FIGS. 4-10B and may include the report information 442 and/or the buffered data information 406. In some implementations, the UE 115 transmits the buffered data information over multiple transmissions or transmission resources.

The wireless communication device (e.g., UE or base station) may execute additional blocks (or the wireless communication device may be configured further perform additional operations) in other implementations. For example, the wireless communication device (e.g., the UE 115) may perform one or more operations described above, such as described with reference to FIGS. 4, 5, 6A, 6B, 7A, 7B, 9, 10A, and 10B. As another example, the wireless communication device (e.g., the UE 115) may perform one or more aspects as presented below.

In a first aspect, the UE 115 is further configured to: receive a resource allocation indicating one or more transmission resources for data based on transmission of the buffered data information; and transmit the data in the one or more transmission resources based on receipt of the resource allocation.

In a second aspect, alone or in combination with the first aspect, the logical channel information includes or indicates a set of logical channel identifiers or one or more logical channel group identifiers.

In a third aspect, alone or in combination with one or more of the above aspects, to transmit the buffered data information to the second network node based on the logical channel information includes to: determine one or more logical channel identifiers based on the logical channel information; and transmit the buffered data information to the second network node in one or more logical channels corresponding to the one or more logical channel identifiers.

In a fourth aspect, alone or in combination with one or more of the above aspects, the buffered data information includes or corresponds to at least one of: a scheduling request (SR) request for at least one logical channel of the logical channels indicated in the logical channel information; a buffer status report (BSR); a delay status report (DSR); a statistical delay report (SDR); remaining packet delay budget (PDB) information or time wait (Twait) information of the one or more of the ongoing uplink packets; or remaining PDB information or Twait information for at least one logical channel of the logical channels indicated in the logical channel information.

In a fifth aspect, alone or in combination with one or more of the above aspects, the BSR, the DSR, the SDR, or a combination thereof are low resolution and provide an indication with respect to a single threshold per logical channel of the logical channels indicated by the logical channel information.

In a sixth aspect, alone or in combination with one or more of the above aspects, the BSR, the DSR, the SDR, or a combination thereof are high resolution and provide an indication with respect to multiple thresholds per logical channel of the logical channels indicated by the logical channel information.

In a seventh aspect, alone or in combination with one or more of the above aspects, the buffered data information is included in a buffer status report (BSR), and wherein the BSR comprises a MAC CE.

In an eighth aspect, alone or in combination with one or more of the above aspects, the control channel transmission includes or corresponds to downlink control information (DCI), and wherein the DCI comprises an uplink scheduling DCI, a downlink scheduling DCI, or a control DCI.

In a ninth aspect, alone or in combination with one or more of the above aspects, the control channel transmission includes or corresponds to layer 1 signaling, layer 2 signaling, or layer 3 signaling.

In a tenth aspect, alone or in combination with one or more of the above aspects, the one or more uplink resources correspond to multiple transmit opportunities, and wherein the buffered data information is transmitted included in multiple transmissions.

In an eleventh aspect, alone or in combination with one or more of the above aspects, the one or more uplink resources include or correspond to PUCCH resources, PUSCH resources, or a combination thereof.

In a twelfth aspect, alone or in combination with one or more of the above aspects, the PUCCH resources include dedicated resources, SR resources, HARQ-ACK resources, CSI-RS resources, or a combination thereof, and wherein the PUSCH resources include dedicated resources, CSI-RS resources, or a combination thereof.

In a thirteenth aspect, alone or in combination with one or more of the above aspects, the UE 115 is further configured to: receive resource configuration information indicating a plurality of SR resources, HARQ-ACK resources, or CSI-RS resources for the first network node.

In a fourteenth aspect, alone or in combination with one or more of the above aspects, the one or more uplink resources include or correspond to layer 1 resources, layer 2 resources, layer 3 resources, or a combination thereof.

In a fifteenth aspect, alone or in combination with one or more of the above aspects, the control channel transmission comprises an uplink scheduling DCI, and wherein the one or more resources include or correspond to PUCCH resources indicated in the uplink scheduling DCI, PUSCH resources indicated in the uplink scheduling DCI, a PUSCH allocation indicated in the uplink scheduling DCI, or a combination thereof.

In a sixteenth aspect, alone or in combination with one or more of the above aspects, the control channel transmission comprises an uplink scheduling DCI, wherein the uplink scheduling DCI indicates a transmission resource for second data, and the at least one processor is further configured to: transmit a first PUSCH for the second data in the transmission resource.

In a seventeenth aspect, alone or in combination with one or more of the above aspects, the control channel transmission comprises an uplink scheduling DCI, the uplink scheduling DCI indicates a transmission resource for second data, and wherein the at least one processor is further configured to: transmit a first PUSCH for the second data and at least a portion of the buffered data information in the transmission resource.

In an eighteenth aspect, alone or in combination with one or more of the above aspects, the control channel transmission comprises a downlink scheduling DCI, and the one or more resources include or correspond to: HARQ-ACK resource associated with a PDSCH scheduled by the downlink scheduling DCI; a PUCCH resource indicated in the downlink scheduling DCI; a PUSCH allocation indicated in the downlink scheduling DCI; or a combination thereof.

In a nineteenth aspect, alone or in combination with one or more of the above aspects, the control channel transmission comprises a downlink scheduling DCI, the downlink scheduling DCI indicates a transmission resource for second data, and the at least one processor is further configured to: receive a PDSCH for the second data; and transmit feedback information in feedback information resources for the PDSCH.

In a twentieth aspect, alone or in combination with one or more of the above aspects, the control channel transmission comprises a downlink scheduling DCI, the downlink scheduling DCI indicates a transmission resource for second data, and the at least one processor is further configured to: receive a PDSCH for the second data; and transmit feedback information and at least a portion of the buffered data information in feedback information resources for the PDSCH.

In a twenty-first aspect, alone or in combination with one or more of the above aspects, the buffered data information is included in a HARQ ACK transmission and indicates a combined indication for one or more LC IDs indicated by the logical channel information, and wherein the at least one processor is configured to: generate a particular combined indication to indicate HARQ-feedback information and buffered data parameter information for a particular LC ID, where the buffered data parameter information includes remaining packet delay budget (PDB) information, time wait (Twait) information, buffer status information, or a delay status information.

In a twenty-second aspect, alone or in combination with one or more of the above aspects, the at least one processor is configured to: receive threshold information for one or more buffered data parameters in the control channel transmission or in a second control channel transmission.

In a twenty-third aspect, alone or in combination with one or more of the above aspects, the at least one processor is further configured to: compare stored buffered data parameter information of each LC ID indicated in the control channel transmission to a buffered data parameter condition; and generate the buffered data information based on the comparisons, wherein the HARQ ACK transmission includes a plurality of bits for each LC IDs of the DCI indicating an acknowledgment and at least one indication for buffered data parameter.

In a twenty-fourth aspect, alone or in combination with one or more of the above aspects, the at least one processor is further configured to: compare stored buffered data parameter information of each LC ID indicated in the control channel transmission to a buffered data parameter condition; select the LC IDs of the LC IDs based on satisfaction of the buffered data parameter condition; and generate the buffered data information based on the comparisons, wherein the buffered data information includes buffered data information for the selected LC IDs.

In a twenty-fifth aspect, alone or in combination with one or more of the above aspects, the at least one processor is further configured to: compare stored buffered data parameter information of second LC IDs not indicated in the control channel transmission to a buffered data parameter condition, the second LC ID corresponding to one or more LC IDs of configured or active LC IDs indicated by the second network node; select additional LC IDs of the second LC IDs based on satisfaction of the buffered data parameter condition; and generate the buffered data information based on the selected additional LC IDs, wherein the buffered data information includes buffered data information for the selected additional LC IDs.

In a twenty-sixth aspect, alone or in combination with one or more of the above aspects, the at least one processor is further configured to: determine which LC IDs to report from the LC IDs indicated in the control channel transmission and optionally, from a list of configured LC IDs, based on one or more buffered data parameter conditions; and transmit, prior to transmitting the buffered data information, uplink control information indicating the determined LC IDs which the first network node will report in the buffered data information.

In a twenty-seventh aspect, alone or in combination with one or more of the above aspects, the buffered data information includes a scheduling request (SR), and the at least one processor is configured to: determine, prior to transmitting the buffered data information, whether a next SR occasion satisfies a SR to HARQ-ACK time interval condition (e.g., condition for a time interval between a SR resource for a next SR occasion and a HARQ-ACK resource for a next HARQ-ACK occasion and/or the HARQ-ACK occasion which provides feedback for a transmission scheduled by the DCI which indicated the logical channels); and transmit a HARQ-ACK transmission in the HARQ-ACK resource based on determining that the SR to HARQ-ACK time interval condition is not satisfied; and transmit the buffered data information in the next SR resource based on determining that that the SR to HARQ-ACK time interval condition is not satisfied.

In a twenty-eighth aspect, alone or in combination with one or more of the above aspects, the buffered data information includes a scheduling request (SR), and the at least one processor is configured to: determine, prior to transmitting the buffered data information, whether a next SR occasion satisfies a SR to HARQ-ACK time interval condition; and transmit HARQ-ACK information and at least a portion of the buffered data information in a HARQ-ACK transmission and in the HARQ-ACK resource based on determining that SR to HARQ-ACK time interval condition is satisfied, wherein the portion of the buffered data information transmitted in the HARQ-ACK transmission that corresponds to a SR.

In a twenty-ninth aspect, alone or in combination with one or more of the above aspects, the at least one processor is configured to: transmit a second portion of the buffered data information in a SR resource, wherein the second portion of the buffered data information includes or corresponds to BSR information, buffered data parameter information, or a combination thereof.

In a thirtieth aspect, alone or in combination with one or more of the above aspects, the at least one processor is configured to: transmit a third portion of the buffered data information in a third transmission resource, wherein the third transmission resource comprises a PUCCH or PUSCH resource, and wherein the third portion of the buffered data information includes or corresponds to BSR information, buffered data parameter information, or a combination thereof.

In a thirty-first aspect, alone or in combination with one or more of the above aspects, wherein the at least one processor is configured to transmit the buffered data information includes to: multiplex data with at least a portion of the buffered data information to generate multiplexed transmission data; encode the multiplexed transmission data; and transmit the encoded multiplexed transmission data in at least one uplink resource of the one or more uplink resources.

In a thirty-second aspect, alone or in combination with one or more of the above aspects, the at least one processor is configured to transmit the buffered data information includes to: encode data to generate encoded data; encode at least a portion of the buffered data information to generate encoded buffered data information; and assign the encoded data and the encoded buffered data to different transmission resource elements of at least one uplink resource of the one or more uplink resources.

In a thirty-third aspect, alone or in combination with one or more of the above aspects, the control channel transmission is received without prior transmission of a SR or a BSR for the buffered data information.

In a thirty-fourth aspect, alone or in combination with one or more of the above aspects, the buffered data information includes a scheduling request, and wherein the scheduling request is transmitted in a PUCCH transmission.

In a thirty-fifth aspect, alone or in combination with one or more of the above aspects, the buffered data information includes a BSR as a MAC CE, and wherein the MAC CE is included in a PUSCH transmission.

In a thirty-sixth aspect, alone or in combination with one or more of the above aspects, the buffered data information is transmitted in a PUSCH transmission, and the buffered data information includes or corresponds to a layer 1 signal of the PUSCH transmission, a layer 2 signal of the PUSCH transmission, or 1 layer 3 signal of the PUSCH transmission.

In a thirty-seventh aspect, alone or in combination with one or more of the above aspects, the control channel transmission is received without transmission of a prior SR or a prior BSR requesting resources to send the buffered data information.

Accordingly, wireless communication devices may perform enhanced buffered data information reporting operations for wireless communication devices. By performing enhanced buffered data information reporting, throughput can be increased and latency can be reduced through the faster indication of buffered data information and assignment of transmission resources therefore.

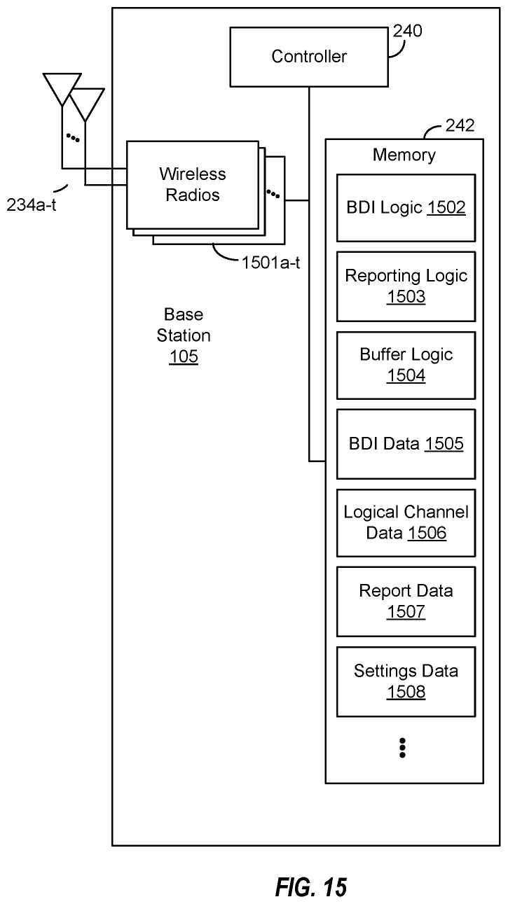

FIG. 13 is a flow diagram illustrating example blocks executed wireless communication device (e.g., a UE or network entity, such as a base station) configured according to an aspect of the present disclosure. The example blocks will also be described with respect to base station 105 as illustrated in FIG. 15. FIG. 15 is a block diagram illustrating base station 105 configured according to one aspect of the present disclosure. Base station 105 includes the structure, hardware, and components as illustrated for base station 105 of FIGS. 2 and/or 4. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1501a-t and antennas 234a-t. Wireless radios 1501a-t includes various components and hardware, as illustrated in FIG. 2 for base station 105, including modulator/demodulators 232a-t, MIMO detector 236, receive processor 238, transmit processor 220, and TX MIMO processor 230. As illustrated in the example of FIG. 15, memory 242 stores BDI logic 1502, reporting logic 1503, buffer logic 1504, BDI data 1505, logical channel data 1506, report data 1507, and settings data 1508. The data (1502-1508) stored in the memory 242 may include or correspond to the data (406, 408, 442, and/or 444) stored in the memory 432 of FIG. 4.

At block 1300, a wireless communication device, such as a network device (e.g., a base station 105), transmits a control channel transmission including logical channel information for transmission of buffered data information to a second network node. The control channel transmission may include or correspond to one or more of the control channel transmission 452 of FIG. 4, the DCI with LC IDs at 520 of FIG. 5, or the PDCCH transmissions of FIGS. 6A-10B. The logical channel information may include or correspond to including logical channel information 408 of FIG. 4. For example, the base station 105 may transmit a control channel transmission 452 or DCI to the UE 115 including logical channel information 408. To illustrate, base station 105 transmits a DCI via wireless radios 1501a-r and antennas 234a-t and including logical channel information 408 indicating one or more LC IDs or LCG IDs.

At block 1301, the wireless communication device transmits the buffered data information to the second network node based on the logical channel information in one or more uplink resources. The buffered data information may include or correspond to one or more of the buffered data information 406 of FIG. 4, the report transmission 454, as described with reference to FIG. 4, or the BDI transmissions of FIGS. 5-10B. For example, the base station 105 receives the buffered data information from the UE 115. To illustrate, a receiver (e.g., receive processor 238 or receiver 436) of the base station receives the report transmission 454 via wireless radios 1501a-r and antennas 234a-t including or indicating the buffered data information 406. As illustrative examples, the buffered data information may include or correspond to one or more indications for BSR/an amount of buffered data, Twait, a PDB, etc., and may be included in a report, such as included in or with report information 442. The report transmission 454 may include or correspond to any of the reports described with reference to FIGS. 4-10B and may include the report information 442 and/or the buffered data information 406. In some implementations, the base station 105 receives the buffered data information over multiple transmissions or transmission resources.

The wireless communication device (e.g., such as a UE or base station) may execute additional blocks (or the wireless communication device may be configured further perform additional operations) in other implementations. For example, the wireless communication device may perform one or more operations as described with reference to FIGS. 4, 5, 6A, 6B, 7A, 7B, 9, 10A, and 10B. As another example, the wireless communication device may perform one or more aspects as described above with reference to FIGS. 12 and 14 or one or more aspects as presented below.

In a first aspect, the wireless communication device is further configured to: transmit a resource allocation indicating one or more transmission resources for data based on transmission of the buffered data information; and receive the data in the one or more transmission resources based on receipt of the resource allocation.

In a second aspect, alone or in combination with the first aspect, the logical channel information includes or indicates a set of logical channel identifiers or one or more logical channel group identifiers.

In a third aspect, alone or in combination with one or more of the above aspects, to receive the buffered data information from the second network node based on the logical channel information includes to: determine one or more logical channel identifiers based on the logical channel information; and receive the buffered data information from the second network node in one or more logical channels corresponding to the one or more logical channel identifiers.

In a fourth aspect, alone or in combination with one or more of the above aspects, the buffered data information includes or corresponds to at least one of: a scheduling request (SR) request for at least one logical channel of the logical channels indicated in the logical channel information; a buffer status report (BSR); a delay status report (DSR); a statistical delay report (SDR); remaining packet delay budget (PDB) information or time wait (Twait) information of the one or more of the ongoing uplink packets; or remaining PDB information or Twait information for at least one logical channel of the logical channels indicated in the logical channel information.

In a fifth aspect, alone or in combination with one or more of the above aspects, the BSR, the DSR, the SDR, or a combination thereof are low resolution and provide an indication with respect to a single threshold per logical channel of the logical channels indicated by the logical channel information.

In a sixth aspect, alone or in combination with one or more of the above aspects, the BSR, the DSR, the SDR, or a combination thereof are high resolution and provide an indication with respect to multiple thresholds per logical channel of the logical channels indicated by the logical channel information.

In a seventh aspect, alone or in combination with one or more of the above aspects, the buffered data information is included in a buffer status report (BSR), and the BSR comprises a MAC CE.

In an eighth aspect, alone or in combination with one or more of the above aspects, the control channel transmission includes or corresponds to downlink control information (DCI), and wherein the DCI comprises an uplink scheduling DCI, a downlink scheduling DCI, or a control DCI.

In a ninth aspect, alone or in combination with one or more of the above aspects, the control channel transmission includes or corresponds to layer 1 signaling, layer 2 signaling, or layer 3 signaling.

In a tenth aspect, alone or in combination with one or more of the above aspects, the one or more uplink resources correspond to multiple transmit opportunities, and wherein the buffered data information is transmitted included in multiple transmissions.

In an eleventh aspect, alone or in combination with one or more of the above aspects, the one or more uplink resources include or correspond to PUCCH resources, PUSCH resources, or a combination thereof.

In a twelfth aspect, alone or in combination with one or more of the above aspects, the PUCCH resources include dedicated resources, SR resources, HARQ-ACK resources, CSI-RS resources, or a combination thereof, and wherein the PUSCH resources include dedicated resources, CSI-RS resources, or a combination thereof.

In a thirteenth aspect, alone or in combination with one or more of the above aspects, the wireless communication device is further configured to: transmit resource configuration information indicating a plurality of SR resources, HARQ-ACK resources, or CSI-RS resources for the second network node.

In a fourteenth aspect, alone or in combination with one or more of the above aspects, the one or more uplink resources include or correspond to layer 1 resources, layer 2 resources, layer 3 resources, or a combination thereof.

In a fifteenth aspect, alone or in combination with one or more of the above aspects, the control channel transmission comprises an uplink scheduling DCI, and wherein the one or more resources include or correspond to PUCCH resources indicated in the uplink scheduling DCI, PUSCH resources indicated in the uplink scheduling DCI, a PUSCH allocation indicated in the uplink scheduling DCI, or a combination thereof.

In a sixteenth aspect, alone or in combination with one or more of the above aspects, the control channel transmission comprises an uplink scheduling DCI, wherein the uplink scheduling DCI indicates a transmission resource for second data, and the at least one processor is further configured to: receive a first PUSCH for the second data in the transmission resource.

In a seventeenth aspect, alone or in combination with one or more of the above aspects, the control channel transmission comprises an uplink scheduling DCI, the uplink scheduling DCI indicates a transmission resource for second data, and wherein the at least one processor is further configured to: receive a first PUSCH for the second data and at least a portion of the buffered data information in the transmission resource.

In an eighteenth aspect, alone or in combination with one or more of the above aspects, the control channel transmission comprises a downlink scheduling DCI, and the one or more resources include or correspond to: HARQ-ACK resource associated with a PDSCH scheduled by the downlink scheduling DCI; a PUCCH resource indicated in the downlink scheduling DCI; a PUSCH allocation indicated in the downlink scheduling DCI; or a combination thereof.

In a nineteenth aspect, alone or in combination with one or more of the above aspects, the control channel transmission comprises a downlink scheduling DCI, the downlink scheduling DCI indicates a transmission resource for second data, and the at least one processor is further configured to: transmit a PDSCH for the second data; and receive feedback information in feedback information resources for the PDSCH.

In a twentieth aspect, alone or in combination with one or more of the above aspects, the control channel transmission comprises a downlink scheduling DCI, the downlink scheduling DCI indicates a transmission resource for second data, and the at least one processor is further configured to: transmit a PDSCH for the second data; and receive feedback information and at least a portion of the buffered data information in feedback information resources for the PDSCH.

In a twenty-first aspect, alone or in combination with one or more of the above aspects, the buffered data information is included in a HARQ ACK transmission and indicates a combined indication for one or more LC IDs indicated by the logical channel information, and wherein the at least one processor is configured to: receive a particular combined indication to indicate HARQ-feedback information and buffered data parameter information for a particular LC ID, where the buffered data parameter information includes remaining packet delay budget (PDB) information, time wait (Twait) information, buffer status information, or a delay status information.

In a twenty-second aspect, alone or in combination with one or more of the above aspects, the at least one processor is configured to: transmit threshold information for one or more buffered data parameters in the control channel transmission or in a second control channel transmission.

In a twenty-third aspect, alone or in combination with one or more of the above aspects, the at least one processor is further configured to: transmit a buffered data parameter condition; and wherein the HARQ ACK transmission includes a plurality of bits for each LC IDs of the DCI indicating an acknowledgment and at least one indication for buffered data parameter.

In a twenty-fourth aspect, alone or in combination with one or more of the above aspects, the buffered data information includes buffered data information for additional LC IDs selected by the second network node.

In a twenty-fifth aspect, alone or in combination with one or more of the above aspects, the buffered data information does not include buffered data information for every logical channel indicated in the control channel transmission.

In a twenty-sixth aspect, alone or in combination with one or more of the above aspects, the at least one processor is further configured to: configure a set of active logical channels.

In a twenty-seventh aspect, alone or in combination with one or more of the above aspects, the buffered data information includes a scheduling request (SR), and the at least one processor is configured to: determine, prior to receiving the buffered data information, whether a next SR occasion satisfies a SR to HARQ-ACK time interval condition; and receive a HARQ-ACK transmission in the HARQ-ACK resource based on determining that the SR to HARQ-ACK time interval condition is not satisfied; and receive the buffered data information in the next SR resource based on determining that that the SR to HARQ-ACK time interval condition is not satisfied.

In a twenty-eighth aspect, alone or in combination with one or more of the above aspects, the buffered data information includes a scheduling request (SR), and the at least one processor is configured to: determine, prior to receiving the buffered data information, whether a next SR occasion satisfies a SR to HARQ-ACK time interval condition (e.g., a time from a SR resource for a next SR occasion and a HARQ-ACK resource for a next HARQ-ACK occasion and/or the HARQ-ACK occasion which provides feedback for a transmission scheduled by the DCI which indicated the logical channels); and receive HARQ-ACK information and at least a portion of the buffered data information in a HARQ-ACK transmission and in the HARQ-ACK resource based on determining that SR to HARQ-ACK time interval condition is satisfied, wherein the portion of the buffered data information received in the HARQ-ACK transmission that corresponds to a SR.

In a twenty-ninth aspect, alone or in combination with one or more of the above aspects, the at least one processor is configured to: receive a second portion of the buffered data information in a SR resource, wherein the second portion of the buffered data information includes or corresponds to BSR information, buffered data parameter information, or a combination thereof.

In a thirtieth aspect, alone or in combination with one or more of the above aspects, the at least one processor is configured to: receive a third portion of the buffered data information in a third transmission resource, wherein the third transmission resource comprises a PUCCH or PUSCH resource, and wherein the third portion of the buffered data information includes or corresponds to BSR information, buffered data parameter information, or a combination thereof.

In a thirty-first aspect, alone or in combination with one or more of the above aspects, wherein the at least one processor is configured to receive the buffered data information includes to: demultiplex multiplexed transmission data to generate data and at least a portion of the buffered data information.

In a thirty-second aspect, alone or in combination with one or more of the above aspects, the at least one processor is configured to receive the buffered data information includes to: decode at least a portion of the buffered data information to generate decoded buffered data information.

In a thirty-third aspect, alone or in combination with one or more of the above aspects, the control channel transmission is transmitted without prior receipt of a SR or a BSR for the buffered data information.

In a thirty-fourth aspect, alone or in combination with one or more of the above aspects, the buffered data information includes a scheduling request, and wherein the scheduling request is received in a PUCCH transmission.

In a thirty-fifth aspect, alone or in combination with one or more of the above aspects, the buffered data information includes a BSR as a MAC CE, and wherein the MAC CE is included in a PUSCH transmission.

In a thirty-sixth aspect, alone or in combination with one or more of the above aspects, the buffered data information is received in a PUSCH transmission, and the buffered data information includes or corresponds to a layer 1 signal of the PUSCH transmission, a layer 2 signal of the PUSCH transmission, or 1 layer 3 signal of the PUSCH transmission.

In a thirty-seventh aspect, alone or in combination with one or more of the above aspects, the control channel transmission is transmitted without receipt of a SR or a BSR requesting resources for the buffered data information.

Accordingly, wireless communication devices may perform enhanced buffered data information reporting operations for wireless communication devices. By performing enhanced buffered data information reporting, throughput can be increased and latency can be reduced through the faster indication of buffered data information and assignment of transmission resources therefore.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-14 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A first network node for wireless communication, comprising:
at least one processor; and
a memory coupled to the at least one processor,
wherein the at least one processor is configured to:
receive a control channel transmission including logical channel information for transmission of buffered data information from a second network node; and
transmit the buffered data information to the second network node based on the logical channel information in one or more uplink resources.

2. The first network node of claim 1, wherein the at least one processor is further configured to:
receive a resource allocation indicating one or more transmission resources for data based on transmission of the buffered data information; and
transmit the data in the one or more transmission resources based on receipt of the resource allocation.

3. The first network node of claim 1, wherein the logical channel information includes or indicates a set of logical channel identifiers or one or more logical channel group identifiers.

4. The first network node of claim 3, wherein the at least one processor configured to transmit the buffered data information to the second network node based on the logical channel information includes to:
determine one or more logical channel identifiers based on the logical channel information; and
transmit the buffered data information to the second network node in one or more logical channels corresponding to the one or more logical channel identifiers.

5. The first network node of claim 1, wherein the buffered data information includes or corresponds to at least one of:
a scheduling request (SR) request for at least one logical channel of the logical channels indicated in the logical channel information;
a buffer status report (BSR);
a delay status report (DSR);
a statistical delay report (SDR);
remaining packet delay budget (PDB) information or time wait (Twait) information of one or more scheduled uplink packets; or
remaining PDB information or Twait information for at least one logical channel of the logical channels indicated in the logical channel information.

6. The first network node of claim 5, wherein the BSR, the DSR, the SDR, or a combination thereof are low resolution and provide an indication with respect to a single threshold per logical channel of the logical channels indicated by the logical channel information.

7. The first network node of claim 5, wherein the BSR, the DSR, the SDR, or a combination thereof are high resolution and provide an indication with respect to multiple thresholds per logical channel of the logical channels indicated by the logical channel information.

8. The first network node of claim 5, wherein the buffered data information is included in a buffer status report (BSR), and wherein the BSR comprises a medium access control control element (MAC CE).

9. The first network node of claim 1, wherein the control channel transmission includes or corresponds to downlink control information (DCI), and wherein the DCI comprises an uplink scheduling DCI, a downlink scheduling DCI, or a control DCI.

10. The first network node of claim 1, wherein the one or more uplink resources correspond to multiple transmit opportunities, and wherein the buffered data information is transmitted included in multiple transmissions.

11. The first network node of claim 1, wherein the one or more uplink resources include or correspond to physical uplink control channel (PUCCH) resources, physical uplink shared channel (PUSCH) resources, or a combination thereof.

12. The first network node of claim 11, wherein the PUCCH resources include dedicated resources, scheduling request (SR) resources, hybrid automatic repeat request acknowledgement (HARQ-ACK) resources, channel state information reference signal (CSI-RS) resources, or a combination thereof, and wherein the PUSCH resources include dedicated resources, CSI-RS resources, or a combination thereof.

13. The first network node of claim 1, wherein the at least one processor is further configured to:
receive resource configuration information indicating a plurality of scheduling request (SR) resources, hybrid automatic repeat request acknowledgement (HARQ-ACK) resources, or channel state information reference signal (CSI-RS) resources for the first network node.

14. The first network node of claim 1, wherein the control channel transmission comprises an uplink scheduling downlink control information (DCI), and wherein the one or more uplink resources include or correspond to physical uplink control channel (PUCCH) resources indicated in the uplink scheduling DCI, physical uplink shared channel (PUSCH) resources indicated in the uplink scheduling DCI, a PUSCH allocation indicated in the uplink scheduling DCI, or a combination thereof.

15. The first network node of claim 1, wherein the control channel transmission comprises an uplink scheduling downlink control information (DCI), wherein the uplink scheduling DCI indicates a transmission resource for second data, and wherein the at least one processor is further configured to:
transmit a first physical uplink shared channel (PUSCH) for the second data in the transmission resource.

16. The first network node of claim 1, wherein the control channel transmission comprises an uplink scheduling downlink control information (DCI), wherein the uplink scheduling DCI indicates a transmission resource for second data, and wherein the at least one processor is further configured to:
transmit a first physical uplink shared channel (PUSCH) for the second data and at least a portion of the buffered data information in the transmission resource.

17. The first network node of claim 1, wherein the control channel transmission comprises a downlink scheduling downlink control information (DCI), and wherein the one or more uplink resources include or correspond to:
a hybrid automatic repeat request acknowledgement (HARQ-ACK) resource associated with a physical downlink shared channel (PDSCH) scheduled by the downlink scheduling DCI;
a physical uplink control channel (PUCCH) resource indicated in the downlink scheduling DCI;
a physical uplink shared channel (PUSCH) allocation indicated in the downlink scheduling DCI; or
a combination thereof.

18. The first network node of claim 1, wherein the control channel transmission comprises a downlink scheduling downlink control information (DCI), wherein the downlink scheduling DCI indicates a transmission resource for second data, and wherein the at least one processor is further configured to:
receive a physical downlink shared channel (PDSCH) for the second data; and
transmit feedback information in feedback information resources for the PDSCH.

19. The first network node of claim 1, wherein the control channel transmission comprises a downlink scheduling downlink control information (DCI), wherein the downlink scheduling DCI indicates a transmission resource for second data, and wherein the at least one processor is further configured to:
receive a physical downlink shared channel (PDSCH) for the second data; and
transmit feedback information and at least a portion of the buffered data information in feedback information resources for the PDSCH.

20. The first network node of claim 1, wherein the buffered data information is included in a hybrid automatic repeat request acknowledgement (HARQ-ACK) transmission and indicates a combined indication for one or more logical channel identifiers (LC IDs) indicated by the logical channel information, and wherein the at least one processor is configured to:
generate a particular combined indication to indicate HARQ-feedback information and buffered data parameter information for a particular LC ID of the one or more LC IDs, wherein the buffered data parameter information includes remaining packet delay budget (PDB) information, time wait (Twait) information, buffer status information, or a delay status information.

21. The first network node of claim 20, wherein the at least one processor is further configured to:
compare stored buffered data parameter information of each LC ID indicated in the control channel transmission to a buffered data parameter condition; and
generate the buffered data information based on the comparisons, wherein the HARQ ACK transmission includes a plurality of bits for each LC ID of the control channel transmission indicating an acknowledgment and at least one indication for buffered data parameter.

22. The first network node of claim 1, wherein the at least one processor is further configured to:
compare stored buffered data parameter information of each logical channel of a plurality of logical channels indicated by the logical channel information in the control channel transmission to a buffered data parameter condition;
select one or more logical channels of the plurality of logical channels based on satisfaction of the buffered data parameter condition; and
generate the buffered data information based on the comparisons, wherein the buffered data information includes buffered data information for the selected one or more logical channels.

23. The first network node of claim 1, wherein the at least one processor is further configured to:
compare stored buffered data parameter information of second logical channels not indicated by the logical channel information in the control channel transmission to a buffered data parameter condition, the second logical channels corresponding to one or more logical channels of configured or active logical channels indicated by the second network node;
select additional logical channels of the second logical channels based on satisfaction of the buffered data parameter condition; and
generate the buffered data information based on the selected additional logical channels, wherein the buffered data information includes buffered data information for the selected additional logical channels.

24. The first network node of claim 1, wherein the at least one processor is further configured to:
determine which logical channels to report from a plurality of logical channels indicated by the logical channel information in the control channel transmission and optionally, from a list of network configured logical channels, based on one or more buffered data parameter conditions; and
transmit, prior to transmitting the buffered data information, uplink control information indicating the determined logical channels which the first network node will report the buffered data information.

25. The first network node of claim 1, wherein the buffered data information includes a scheduling request (SR), and wherein the at least one processor is configured to:
determine, prior to transmitting the buffered data information, whether a next SR occasion satisfies a SR to hybrid automatic repeat request acknowledgement (HARQ-ACK) time interval condition; and
transmit a HARQ-ACK transmission in a HARQ-ACK resource based on determining that the SR to HARQ-ACK time interval condition is not satisfied; and
transmit the buffered data information in resources of the next SR occasion based on determining that that the SR to HARQ-ACK time interval condition is not satisfied.

26. The first network node of claim 1, wherein the buffered data information includes a scheduling request (SR), and wherein the at least one processor is configured to:
determine, prior to transmitting the buffered data information, whether a next SR occasion satisfies a SR to hybrid automatic repeat request acknowledgement (HARQ-ACK) time interval condition; and
transmit HARQ-ACK information and at least a portion of the buffered data information in a HARQ-ACK transmission and in a HARQ-ACK resource based on determining that SR to HARQ-ACK time interval condition is satisfied, wherein the portion of the buffered data information transmitted in the HARQ-ACK transmission that corresponds to a SR.

27. The first network node of claim 26, wherein the at least one processor is configured to:
transmit a second portion of the buffered data information in a SR resource, wherein the second portion of the buffered data information includes or corresponds to buffer status report (BSR) information, buffered data parameter information, or a combination thereof.

28. The first network node of claim 27, wherein the at least one processor is configured to:
transmit a third portion of the buffered data information in a third transmission resource, wherein the third transmission resource comprises a physical uplink control channel (PUCCH) or a physical uplink shared channel (PUSCH) resource, and wherein the third portion of the buffered data information includes or corresponds to BSR information, buffered data parameter information, or a combination thereof.

29. A first network node for wireless communication, comprising:
at least one processor; and
a memory coupled to the at least one processor,
wherein the at least one processor is configured to:
transmit a control channel transmission including logical channel information for transmission of buffered data information to a second network node; and
receive the buffered data information from the second network node based on the logical channel information in one or more uplink resources.

30. The first network node of claim 29, wherein the control channel transmission is transmitted without receipt of a scheduling request (SR) or a buffer status request (BSR) requesting resources for the buffered data information.
